(19) United States
(12) Patent Application Publication
(10) Pub. No.: US 2025/0386103 A1
(43) Pub. Date: Dec. 18, 2025

(54) IMAGE PROCESSING DEVICE, IMAGE PROCESSING METHOD, AND PROGRAM

(71) Applicant: SONY GROUP CORPORATION, TOKYO (JP)

(72) Inventor: MASATSUGU HIRAYAMA, TOKYO (JP)

(21) Appl. No.: 18/849,522

(22) PCT Filed: Feb. 24, 2024
(86) PCT No.: PCT/JP2023/006808

§ 371 Date: Sep. 22, 2024

(30) Foreign Application Priority Data
Mar. 30, 2022 (JP) 2022-056725

(51) Int. Cl. H04N 23/745; H04N 23/61

(52) U.S. Cl. CPC H04N 23/745; H04N 23/61

(57) ABSTRACT

An image processing device that efficiently detects a flicker correction target object and performs a flicker correction process with high accuracy and at high speed is to be obtained. The image processing device includes a flicker correction unit that performs a flicker correction process. The flicker correction unit includes: a flicker correction target object detection unit that detects, from an image, a flicker correction target object that is a subject that is likely to cause a flicker; and an image correction unit that performs a flicker correction process on the image region of the flicker correction target object detected by the flicker correction target object detection unit. The flicker correction target object detection unit performs a flicker correction target object detection process, using a learning model.

### TECHNICAL FIELD

The present disclosure relates to an image processing device, an image processing method, and a program. More particularly, the present disclosure relates to an image processing device that performs flicker correction, an image processing method, and a program.

### BACKGROUND ART

In a case where a moving image is captured with a camera, if the subjects include a subject having an output signal change (luminance change) at a predetermined frequency, such as a display or a traffic light, the light output unit of the subject (the light emitting unit of a display or a traffic light) might significantly change in luminance at the time of reproduction of the captured moving image. This is a so-called flicker phenomenon.

A flicker phenomenon is caused by a difference in output luminance of a display, a traffic light, or the like as the subject at the timing to capture each of the image frames constituting the moving image that is being taken with a camera. For example, in a case where the output frequency of a traffic light is 50 Hz, the traffic light periodically repeats blinking 50 times per second.

On the other hand, it is assumed that the imaging frame rate for the moving image being captured by the camera is 30 fps, which is a frame rate at which 30 images are captured per second, for example.

Even if the luminance of the traffic light is the highest luminance at the timing to capture the first captured image frame (F1) at the start of capturing of the moving image by the camera, an output of the traffic light blinking at 50 Hz is not the highest luminance, and the luminance has dropped at the timing to capture the next captured image frame (F2), which is the timing to capture the captured image frame (F2) after a lapse of 1/30 second.

Further, also at the timing to capture a captured image frame (F3) after a lapse of the next 1/30 second, the output of the traffic light has a luminance different from that in the preceding captured image frames (F1 and F2).

As a result, the luminance of the light emitting unit of the traffic light included in each of the image frames (F1, F2, F3, . . . ) constituting the moving image captured by the camera varies among images, and the reproduced moving image is a moving image that causes a flicker.

Note that, for example, Patent Document 1 (Japanese Patent Application Laid-Open No. 2013-121099) is a conventional technique that discloses a configuration for reducing flickers in images captured by a camera.

Patent Document 1 discloses a configuration in which a camera captures two types of images, a long-time exposure image and a short-time exposure image, and a corrected image excluding the influence of any flicker is generated from these images.

However, to capture a plurality of images with different exposure times as described above, a special configuration is required, and there is the problem of high costs.

### CITATION LIST

### Patent Document

Patent Document 1: Japanese Patent Application Laid-Open No. 2013-121099

### SUMMARY OF THE INVENTION

### Problems to be Solved by the Invention

The present disclosure has been made in view of the above problems, for example, and aims to provide an image processing device capable of generating an image without flickers or with reduced flickers, not using any special configuration that captures images with a plurality of different exposure times, an image processing method, and a program.

### Solutions to Problems

A first aspect of the present disclosure lies in an image processing device that includes
a flicker correction unit that performs a flicker correction process, in which
the flicker correction unit includes:
a flicker correction target object detection unit that detects, from an image, a flicker correction target object that is a subject that is likely to cause a flicker; and
an image correction unit that performs a flicker correction process on the image region of the flicker correction target object detected by the flicker correction target object detection unit, and
the flicker correction target object detection unit performs a flicker correction target object detection process, using a learning model.

Further, a second aspect of the present disclosure lies in an image processing method implemented in an image processing device, in which
the image processing device includes a flicker correction unit that performs a flicker correction process,
the flicker correction unit performs
a flicker correction target object detection process to detect, from an image, a flicker correction target object that is a subject that is likely to cause a flicker, and
an image correction process to perform a flicker correction process on the image region of the flicker correction target object detected in the flicker correction target object detection process, and
a flicker correction target object detection process using a learning model is performed in the flicker correction target object detection process.

Further, a third aspect of the present disclosure lies in a program for causing an image processing device to perform image processing, in which
the image processing device includes a flicker correction unit that performs a flicker correction process,
the program causes the flicker correction unit to perform
a flicker correction target object detection process to detect, from an image, a flicker correction target object that is a subject that is likely to cause a flicker, and
an image correction process to perform a flicker correction process on the image region of the flicker correction target object detected in the flicker correction target object detection process, and
a flicker correction target object detection process using a learning model is performed in the flicker correction target object detection process.

Note that a program according to the present disclosure is a program that can be provided to an information processing device or a computer system that can execute various program codes, for example, through a storage medium or a communication medium provided in a computer-readable format. By providing such a program in a computer-readable format, processing according to the program is performed in an information processing device or a computer system.

Still other objects, features, and advantages of the present disclosure will become apparent from a more detailed description based on embodiments of the present disclosure as described later and the accompanying drawings. Note that, in the present specification, a system is a logical set configuration of a plurality of devices, and is not limited to a system in which devices of the respective configurations are in the same housing.

With a configuration according to an embodiment of the present disclosure, an image processing device that efficiently detects a flicker correction target object and performs a flicker correction process with high accuracy and at high speed is obtained.

Specifically, the image processing device includes a flicker correction unit that performs a flicker correction process, for example. The flicker correction unit includes: a flicker correction target object detection unit that detects, from an image, a flicker correction target object that is a subject that is likely to cause a flicker; and an image correction unit that performs a flicker correction process on the image region of the flicker correction target object detected by the flicker correction target object detection unit. The flicker correction target object detection unit performs a flicker correction target object detection process, using a learning model.

With this configuration, an image processing device that efficiently detects a flicker correction target object and performs a flicker correction process with high accuracy and at high speed is obtained.

Note that the effects described herein are merely examples and are not restrictive, and additional effects may also be provided.

### BRIEF DESCRIPTION OF DRAWINGS

FIG. 1 is a diagram for explaining a specific example of a flicker phenomenon.

FIG. 2 is a diagram for explaining a specific example and the cause of a flicker phenomenon.

FIG. 3 is a diagram for explaining a specific example and the cause of a flicker phenomenon.

FIG. 4 is a diagram for explaining an example configuration of an image processing device according to the present disclosure.

FIG. 5 is a diagram for explaining an example configuration in a case where an external device outside a camera, such as a PC that receives an input of an image captured by the camera and performs image processing, is set as an image processing device according to the present disclosure.

FIG. 6 is a diagram illustrating an example configuration of a flicker correction unit 150 according to a first embodiment of the present disclosure.

FIG. 7 is a diagram for explaining a learning model that is used by a flicker correction target object detection unit (a first learning model).

FIG. 8 is a diagram for explaining a specific example of the process to be performed by the flicker correction target object detection unit (the first learning model).

FIG. 9 is a flowchart for explaining the sequence in a flicker correction process to be performed by an image processing device according to the present disclosure.

FIG. 10 is a diagram for explaining a specific example of a process in which the flicker correction target object detection unit (the first learning model) detects a flicker correction target object, using a learning model (the first learning model).

FIG. 11 is a diagram illustrating an example configuration of a flicker correction unit according to a second embodiment of the present disclosure.

FIG. 12 is a diagram for explaining a second learning model that is used by a flicker correction target object detection unit (second learning model).

FIG. 13 is a diagram for explaining a lighted state of a traffic light and a luminance change mode in a blinking state.

FIG. 14 is a diagram for explaining the reason why a process of distinguishing a lighted state and a blinking state from each other becomes possible by adopting the second learning model that is used in the second embodiment.

FIG. 15 is a diagram for explaining the reason why a process of distinguishing a lighted state and a blinking state from each other becomes possible by adopting the second learning model that is used in the second embodiment.

FIG. 16 is a diagram for explaining a specific example of a case where the flicker correction target object detection unit (the second learning model) according to the second embodiment detects a flicker correction target object in accordance with frame rate information about the camera.

FIG. 17 is a diagram for explaining a configuration in which the flicker correction target object detection unit (the second learning model) selects a learning model in accordance with the camera frame rate.

FIG. 18 is a diagram for explaining a specific example of a process to be performed by the flicker correction target object detection unit (the second learning model) according to the second embodiment.

FIG. 19 is a flowchart for explaining the sequence in a flicker correction process to be performed by a flicker correction unit according to the second embodiment.

FIG. 20 is a diagram for explaining a specific example in which an image of a flicker correction target object in the lowest luminance state is captured in all image frames consecutively captured by a camera.

FIG. 21 is a diagram for explaining an example in which a correction error occurs as a result of flicker correction in a case where all the consecutively captured image frames are images with the minimum luminance (Lmin).

FIG. 22 is a diagram illustrating an example configuration of a flicker correction unit according to a third embodiment of the present disclosure.

FIG. 23 is a diagram for explaining a specific example of a warning output to a user during image capturing.

FIG. 24 is a diagram for explaining an example of an image capturing timing change in a case where a process of stopping image capturing is performed after a warning message is checked, and a process of restarting image capturing is then performed.

FIG. 25 is a diagram for explaining an example configuration for automatically shifting the image capturing timing.

FIG. 26 is a diagram for explaining an example of a process of changing the moving image capturing timing to be performed by an imaging timing control unit.

FIG. 27 is a diagram for explaining an example configuration of a flicker correction unit including a warning output unit and an imaging timing control unit.

FIG. 28 is a flowchart for explaining the sequence in a flicker correction process to be performed by a flicker correction unit according to the third embodiment.

FIG. 29 is a diagram for explaining an example of the hardware configuration of an image processing device according to the present disclosure.

### MODE FOR CARRYING OUT THE INVENTION

The following is a detailed description of an image processing device, an image processing method, and a program according to the present disclosure, with reference to the drawings. Note that explanation will be made in the following order.
1. Outline of a flicker phenomenon
2. Example configuration of an image processing device according to the present disclosure
3. (First embodiment) the configuration of and processes to be performed by a flicker correction unit according to a first embodiment of the present disclosure
4. (Second embodiment) the configuration of and processes to be performed by a flicker correction unit according to a second embodiment of the present disclosure
5. (Third embodiment) the configuration of and processes to be performed by a flicker correction unit according to a third embodiment of the present disclosure
6. Example of the hardware configuration of an image processing device
7. Summary of configurations according to the present disclosure

### 1. Outline of a Flicker Phenomenon

First, an outline of a flicker phenomenon is described.

As described above, when there is a subject such as a display or a traffic light whose output signal changes (a luminance change) at a predetermined frequency in a moving image captured with a camera, for example, the image region of a light output unit of any of these subjects (a light emitting unit of a display or a traffic light) might exhibit a severe luminance change, or a so-called flicker phenomenon, at the time of reproduction of the captured moving image.

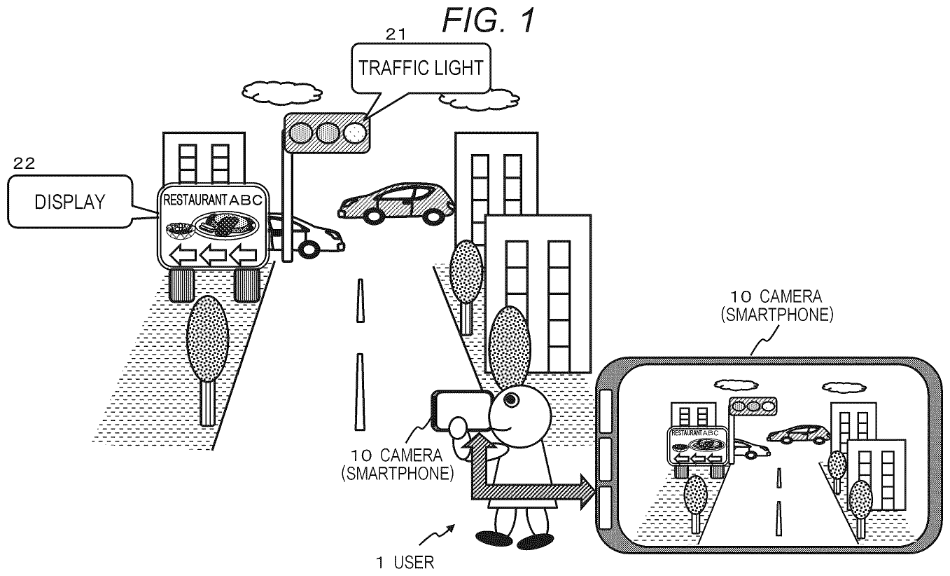

Referring to FIG. 1 and the subsequent drawings, a specific example of a flicker phenomenon and a cause thereof is described below.

FIG. 1 illustrates an example in which a user 1 is taking an image (moving image) with a camera 10. Note that FIG. 1 shows a smartphone having a camera function as an example of the camera 10.

The user 1 is taking a moving image of an intersection with the camera 10.

At the intersection, there are a traffic light 21 and a large-size display 22, and these are also being taken as an image.

However, the outputs (luminances) of the light output units of the traffic light 21, which are red, yellow, and green light output units, change at a predetermined frequency, for example.

The same applies to the display, and the output of the image display unit changes at a predetermined frequency.

These luminance change frequencies are as high as 50 Hz or even higher, for example, and blinking cannot be recognized with the naked eye.

However, when a moving image of such subjects whose output signals change at predetermined intervals like luminance is taken with the camera 10, and the captured moving image is reproduced, the image regions of the light output units (the light emitting units of a display and a traffic light) of these subjects might cause a severe luminance change, a so-called flicker.

As described above, this flicker phenomenon is caused by a difference in output luminance of a display, a traffic light, or the like as the subject at the timing to capture each of the image frames constituting the moving image that is being taken with a camera.

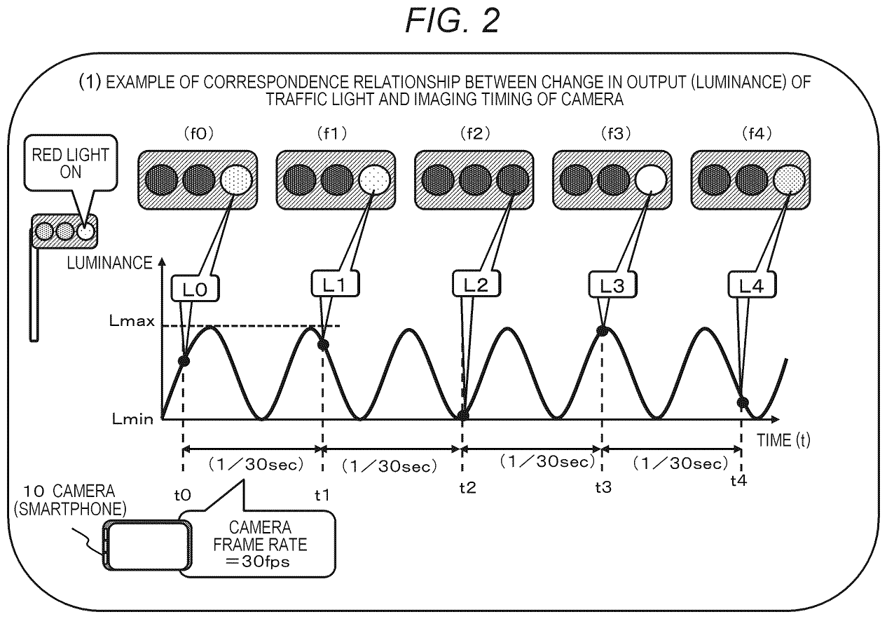

Referring now to FIG. 2, the reason for the occurrence of a flicker phenomenon is described.

FIG. 2 shows the following graph.

### (1) Correspondence Relationship Between the Change in the Output (Luminance) of the Traffic Light and the Image Capturing Timing of the Camera

In the graph (1) shown in FIG. 2, the abscissa axis indicates time, and the ordinate axis indicates the change in the luminance of one light emitting unit during lighting among the three light emitting units (red, yellow, and green) of the traffic light.

Specifically, the graph illustrates the change in the luminance of the red light in a period during which the traffic light is in a red light state, and the red light is on (is emitting light).

The luminance of the red light periodically changes between the minimum luminance (Lmin) and the maximum luminance (Lmax) indicated on the ordinate axis (luminance) of the graph during lighting.

The frequency of the change in the luminance of the red light is 50 Hz, for example, and the luminance change cannot be recognized with the naked eye.

The abscissa axis shown in FIG. 2 is a time (t) axis, and t0, t1, t2, t3, . . . represent the image capturing timings for the respective image frames constituting the moving image at the time to take the moving image with the camera 10.

The camera 10 is a smartphone, for example. Many smartphone cameras has a frame rate of 30 fps while taking a moving image, which means that a smartphone camera takes thirty images in one second.

The time intervals among t0, t1, t2, t3, . . . in the graph shown in FIG. 2 are 1/30 sec, and the camera 10 sequentially captures one image frame at each of times t0, t1, t2, t3, . . . in the graph.

For example, at time t0, an image frame (f0) is captured. After that, the next image frame (f1) is captured after a lapse of 1/30 sec from time to. Further, the next image frame (f2) is captured after a lapse of 1/30 sec from time t1. Thereafter, one image is taken every 1/30 sec in a similar manner.

At a time of reproduction, these image frames are successively reproduced, so that the moving image can be reproduced.

The upper portion of FIG. 2 illustrates the change in the captured image of the traffic light included in each of the image frames (f0, f1, f2, . . . ) captured by the camera 10.

For example, in the image frame (f0) captured at time t0, the luminance of the red light of the traffic light is in a luminance state (L0) in the graph shown in the drawing.

As can be seen from the graph shown in the drawing, the luminance L0 is a luminance appropriately at the midpoint between the minimum luminance (Lmin) and the maximum luminance (Lmax) indicated on the ordinate axis (luminance) of the graph, and the luminance of the red light in the image frame (f0) illustrated in the upper portion of the drawing is an image having a luminance that is approximately half the maximum luminance (Lmax).

After that, in the image frame (f1) captured after a lapse of 1/30 sec from time to, the luminance of the red light of the traffic light is in a luminance state (L1) in the graph shown in the drawing.

The luminance L1 is a luminance slightly closer to the maximum luminance (Lmax) side between the minimum luminance (Lmin) and the maximum luminance (Lmax) indicated on the ordinate axis (luminance) of the graph. Accordingly, the luminance of the red light in the image frame (f1) illustrated in the upper portion of the drawing changes to be slightly higher than the luminance of the red light in the image frame f0 captured at time t0.

After that, in the image frame (f2) captured after a lapse of 1/30 sec from time t1, the luminance of the red light of the traffic light is in a luminance state (L2) in the graph shown in the drawing.

The luminance L2 is approximately the minimum luminance (Lmin). Therefore, the luminance of the red light in the image frame (f2) illustrated in the upper portion of the drawing is approximately the minimum luminance (Lmin), and the image is close to a non-lighted state.

After that, in the image frame (f3) captured after a lapse of 1/30 sec from time t2, the luminance of the red light of the traffic light is in a luminance state (L3) in the graph shown in the drawing.

The luminance L3 is approximately the maximum luminance (Lmax). Accordingly, the luminance of the red light in the image frame (f3) illustrated in the upper portion of the drawing is approximately the maximum luminance (Lmax).

After that, in the image frame (f4) captured after a lapse of 1/30 sec from time t3, the luminance of the red light of the traffic light is in a luminance state (L4) in the graph shown in the drawing.

The luminance L4 is approximately the minimum luminance (Lmin). Therefore, the luminance of the red light in the image frame (f4) illustrated in the upper portion of the drawing is approximately the minimum luminance (Lmin), and the image is close to a non-lighted state.

In this manner, the luminance of the red light of the traffic light included in the image captured by the camera 10 at the respective times t0, t1, t2, t3, . . . indicated in the graph greatly change between image frames that have bene successively captured. As a result, in a case where the captured image is reproduced, the image is a moving image in which the red light actually in a lighted state changes drastically in luminance. That is, the image is a reproduction image in which a flicker has occurred.

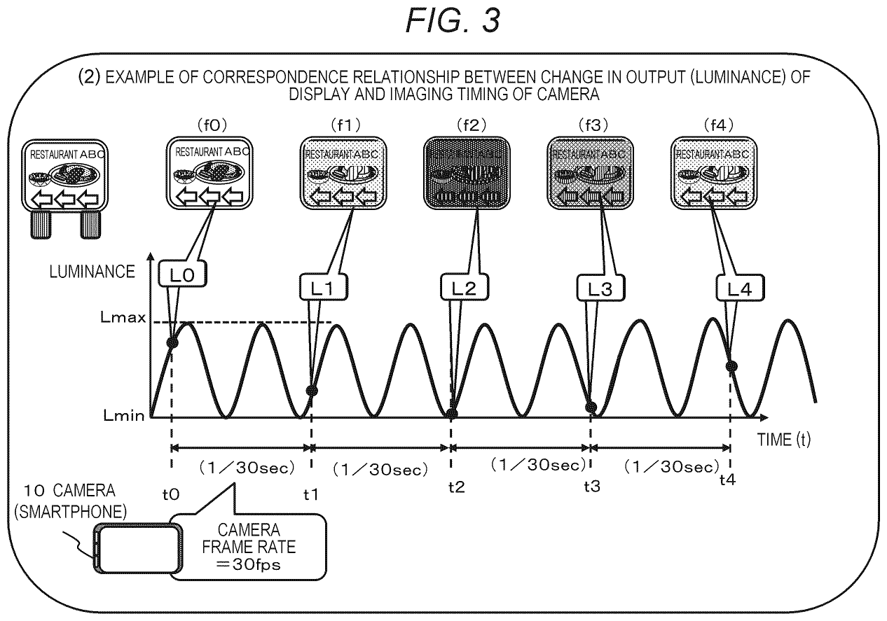

FIG. 3 is a diagram for explaining an example of the occurrence of a flicker in the display 22 illustrated in FIG. 1. FIG. 3 shows the following graph.

### (2) Correspondence Relationship Between the Change in the Output (Luminance) of the Display and the Image Capturing Timing of the Camera

In the graph shown in FIG. 3, the abscissa axis indicates time, and the ordinate axis indicates the change in the luminance of the display, as in the graph in FIG. 2. Note that, in this example, the luminance of the display is the average luminance of the entire display. Note that this is an example in which it is assumed that the display image does not change significantly.

The luminance of the display periodically changes between the minimum luminance (Lmin) and the maximum luminance (Lmax) indicated on the ordinate axis (luminance) of the graph.

The frequency of the change in the luminance of the red light is 80 Hz, for example, and the luminance change cannot be recognized with the naked eye.

The abscissa axis shown in FIG. 3 is a time (t) axis, and t0, t1, t2, t3, . . . represent the image capturing timings for the respective image frames constituting the moving image at the time to take the moving image with the camera 10.

The upper portion of FIG. 3 illustrates the change in the captured image of the display included in each of the image frames (f0, f1, f2, . . . ) captured by the camera 10.

For example, in the image frame (f0) captured at time t0, the luminance of the display is in a luminance state (L0) in the graph shown in the drawing.

As can be seen from the graph shown in the drawing, the luminance L0 is a luminance slightly closer to the maximum luminance (Lmax) side between the minimum luminance (Lmin) and the maximum luminance (Lmax) indicated on the ordinate axis (luminance) of the graph, and the luminance of the display in the image frame (f0) illustrated in the upper portion of the drawing is an image having a luminance that is close to the maximum luminance (Lmax).

After that, in the image frame (f1) captured after a lapse of 1/30 sec from time to, the luminance of the display is in a luminance state (L1) in the graph shown in the drawing.

The luminance L1 is a luminance slightly closer to the minimum luminance (Lmin) side between the minimum luminance (Lmin) and the maximum luminance (Lmax) indicated on the ordinate axis (luminance) of the graph. Therefore, the luminance of the display in the image frame (f1) illustrated in the upper portion of the drawing changes to be lower than the luminance of the display in the image frame (f0) captured at time t0.

After that, in the image frame (f2) captured after a lapse of 1/30 sec from time t1, the luminance of the display is in a luminance state (L2) in the graph shown in the drawing.

The luminance L2 is approximately the minimum luminance (Lmin). Therefore, the luminance of the display in the image frame (f2Z) illustrated in the upper portion of the drawing is approximately the minimum luminance (Lmin), and the image is close to a completely dark image.

After that, in the image frame (f3) captured after a lapse of 1/30 sec from time t2, the luminance of the display is in a luminance state (L3) in the graph shown in the drawing.

The luminance L3 is also approximately the minimum luminance (Lmin). Therefore, the luminance of the display in the image frame (f3) illustrated in the upper portion of the drawing is also approximately the minimum luminance (Lmin), and the image is close to a completely dark image.

After that, in the image frame (f4) captured after a lapse of 1/30 sec from time t3, the luminance of the display is in a luminance state (L4) in the graph shown in the drawing.

The luminance L4 is a luminance approximately at the midpoint between the minimum luminance (Lmin) and the maximum luminance (Lmax). Accordingly, the luminance of the display in the image frame (f4) illustrated in the upper portion of the drawing is an image with a luminance at the midpoint between the minimum luminance (Lmin) and the maximum luminance (Lmax).

In this manner, the luminance of the display included in the image captured by the camera 10 at the respective times to, t1, t2, t3, . . . indicated in the graph greatly change between image frames that have bene successively captured. As a result, in a case where the captured image is reproduced, the image of the display that is actually in a continuous image display on-state is a moving image with drastic luminance changes. That is, the image is a reproduction image in which a flicker has occurred.

An image processing device according to the present disclosure performs a process of eliminating such a flicker phenomenon.

In the description below, the configuration of and the process to be performed by an image processing device according to the present disclosure will be explained.

### 2. Example Configuration of an Image Processing Device According to the Present Disclosure

Next, an example configuration of an image processing device according to the present disclosure is described.

An image processing device according to the present disclosure performs image processing for eliminating the flicker phenomenon described above.

The image processing device according to the present disclosure is designed as a camera, for example. Alternatively, the image processing device may be designed as an external device outside a camera, such as a PC that receives an input of an image captured by the camera and performs image processing.

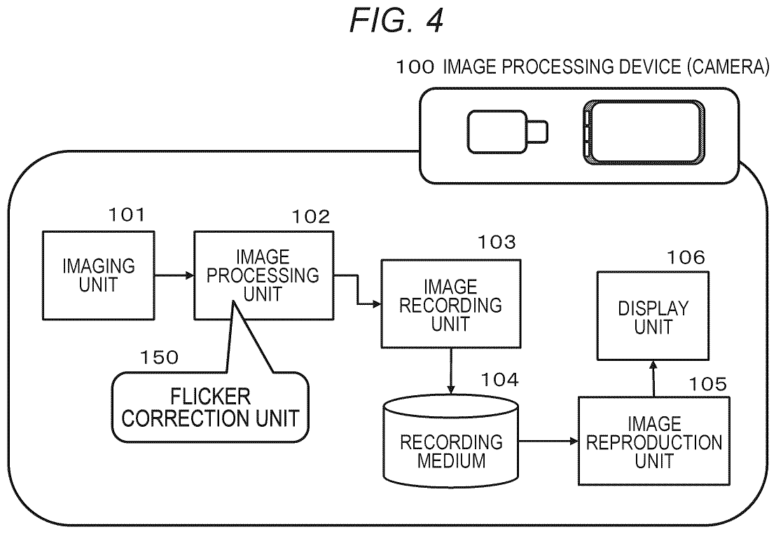

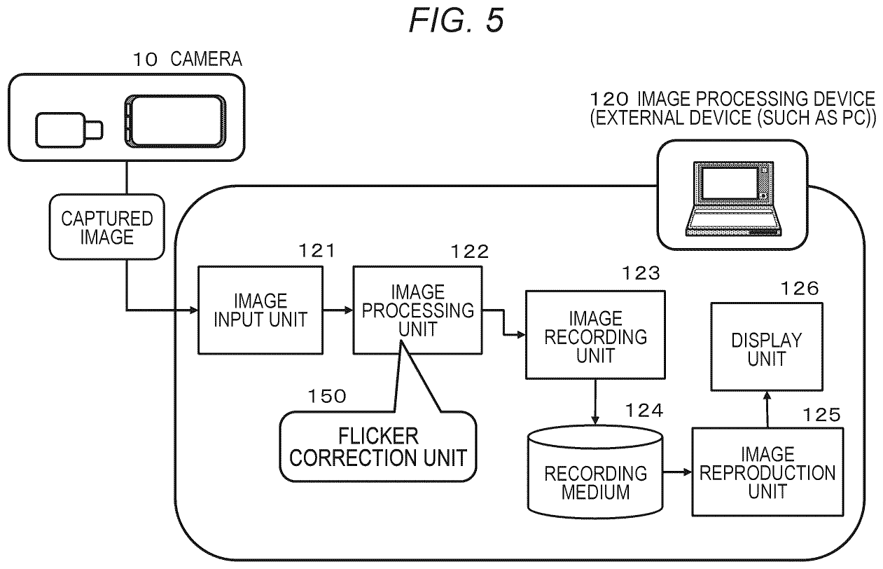

Referring now to FIGS. 4 and 5, an example configuration of the image processing device according to the present disclosure is described.

FIG. 4 is a diagram illustrating an example configuration of an image processing device 100 in a case where a camera that performs imaging is the image processing device according to the present disclosure.

Note that the camera is a camera capable of capturing a moving image, and includes a smartphone having a camera function, for example.

The image processing device 100 illustrated in FIG. 4 includes an imaging unit 101, an image processing unit 102, an image recording unit 103, a recording medium 104, an image reproduction unit 105, and a display unit 106.

The imaging unit 101 captures a moving image. For example, a moving image is captured at a prescribed frame rate such as 30 fps.

Note that the imaging unit 101 is formed with a charge coupled device (CCD) image sensor, a complementary metal oxide semiconductor (CMOS) image sensor, or the like, for example.

The image processing unit 102 performs image processing on image data (a RAW image) that is input from the imaging unit 101. For example, in addition to a noise reduction process for reducing noise included in the input RAW image, signal processing in a general camera is performed, such as a demosaicing process for setting pixel values corresponding to the all colors of RGB at the respective pixel positions in the RAW image, white balance (WB) adjustment, and gamma correction.

Further, the image processing unit 102 includes a flicker correction unit 150.

The flicker correction unit 150 analyzes whether or not there is a subject image that might cause a flicker from each of the image frames constituting the moving image captured by the imaging unit 101, or, in other words, whether or not there is a flicker correction target object. In a case where a flicker correction target object is detected, the flicker correction unit 150 performs a flicker correction process for eliminating or reducing flickers.

The specific configuration of and the process to be performed by the flicker correction unit 150 will be described later.

The corrected image on which various kinds of image processing including the flicker correction process have been performed by the image processing unit 102 is stored into the recording medium 104 via the image recording unit 103.

The image stored in the recording medium 104 is reproduced by the image reproduction unit 105, and is output to the display unit 106.

The moving image to be displayed on the display unit 106 is a high-quality image in which flickers have been eliminated or reduced.

In addition to the camera described with reference to FIG. 4, the image processing device according to the present disclosure can may be designed as an external device outside the camera, such as a PC that receives an input of an image captured by the camera and performs image processing.

Referring now to FIG. 5, an example configuration of the image processing device 120 in a case where an external device outside the camera, such as a PC that receives an input of an image captured by the camera and performs image processing, is set as the image processing device according to the present disclosure is described.

As illustrated in FIG. 5, the image processing device 120 receives an input of a captured image from the camera 10 that captures a moving image, and performs image processing including flicker correction.

The image processing device 120 illustrated in FIG. 5 includes an input unit 121, an image processing unit 122, an image recording unit 123, a recording medium 124, an image reproduction unit 125, and a display unit 126.

The input unit 121 receives an input a captured image from the camera 10 that captures a moving image. Note that the camera 10 captures a moving image at a prescribed frame rate, such as 30 fps, for example. The image frames constituting the moving image captured by the camera 10 are sequentially input to the image processing device 120.

The image processing unit 122 performs image processing on the image data that is input via the input unit 121. Note that, in a case where signal processing in a general camera, such as a noise reduction process, a demosaicing process, white balance (WB) adjustment, or gamma correction, has already been performed in the camera 10, the image processing unit 122 performs a flicker correction process, without performing those processes.

Note that the image processing unit 122 may perform a noise reduction process, white balance (WB) adjustment, gamma correction, and the like as necessary.

Like the flicker correction unit 150 described above with reference to FIG. 4, the flicker correction unit 150 in the image processing unit 122 analyzes whether or not there is a subject image that might cause a flicker from each of the image frames constituting the moving image captured by the camera 10, or, in other words, whether or not there is a flicker correction target object. In a case where a flicker correction target object is detected, the flicker correction unit 150 performs a flicker correction process for eliminating or reducing flickers.

The specific configuration of and the process to be performed by the flicker correction unit 150 will be described later.

The corrected image on which various kinds of image processing including the flicker correction process have been performed by the image processing unit 122 is stored into the recording medium 124 via the image recording unit 123.

The image stored in the recording medium 124 is reproduced by the image reproduction unit 125, and is output to the display unit 126.

The moving image to be displayed on the display unit 126 is a high-quality image in which flickers have been eliminated or reduced.

Note that an image captured by the camera of a smartphone may be transmitted from the smartphone to a server device connected via a network, for example, a series of flicker correction processes may be performed on the server device side, and the image subjected to the flicker correction may be transmitted from the server device back to the smartphone.

In the description below, the configuration of the flicker correction unit 150 formed in the image processing units 102 and 122 in the image processing devices 100 and 120 described with reference to FIGS. 4 and 5, and the details of the processes to be performed will be explained.

Note that, in the description below, a plurality of embodiments of the flicker correction unit 150 will be sequentially explained.

### 3. (First Embodiment) Configuration of and the Processes to Be Performed by a Flicker Correction Unit According to a First Embodiment of the Present Disclosure

First, the configuration of and the processes to be performed by a flicker correction unit according to a first embodiment of the present disclosure are described.

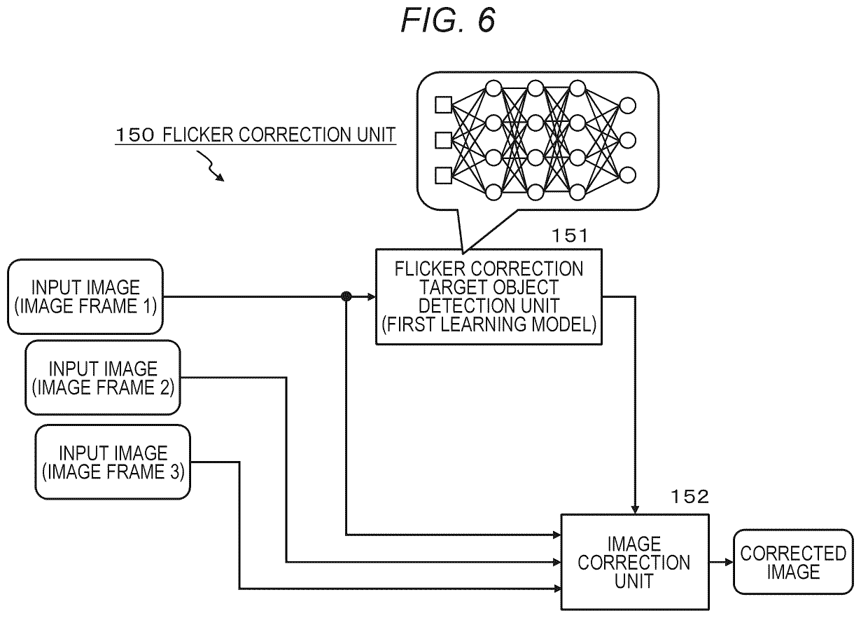

FIG. 6 is a diagram illustrating an example configuration of a flicker correction unit 150 according to the first embodiment of the present disclosure.

As illustrated in FIG. 6, the flicker correction unit 150 according to the present disclosure includes a flicker correction target object detection unit (a first learning model) 151 and an image correction unit 152.

The flicker correction target object detection unit (the first learning model) 151 analyzes whether or not there is a subject that might cause a flicker from each of the image frames constituting a moving image captured by a camera, or whether or not there is a flicker correction target object.

In a case where a flicker correction target object is detected by the flicker correction target object detection unit (the first learning model) 151, the image correction unit 152 performs a flicker correction process for eliminating or reducing flickers.

The flicker correction target object detection unit (the first learning model) 151 uses a learning model generated through a learning process beforehand, to analyze whether or not there is a subject (a subject image) that might cause a flicker from an image captured by the camera, or whether or not there is a flicker correction target object.

The flicker correction target object detection unit (the first learning model) 151 performs a process of detecting a flicker correction target object from an image captured by the camera, using a learning model generated as a result of machine learning to which an algorithm such as a deep neural network (DNN) that is a multilayer neural network, for example, a convolutional neural network (CNN), or a recurrent neural network (RNN) is applied.

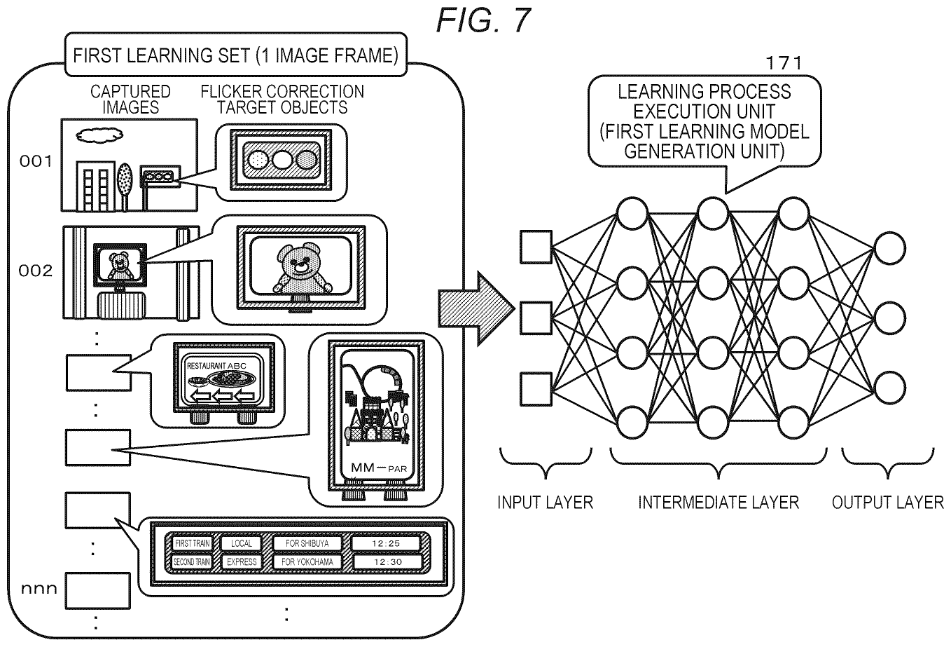

Referring now to FIG. 7, the learning model that is used by the flicker correction target object detection unit (the first learning model) 151 is described.

A learning processing execution unit (a learning model generation unit) 171 illustrated in FIG. 7 receives an input of a “first learning set (image frames)” including images in which various subjects are captured, and performs a learning process.

The “first learning set” to be input is a learning set (a training data set) including various images captured by the camera, and identification information about the flicker correction target object included in each of the images.

The input images are an image including a display, an image including a traffic light, an image including an electric bulletin board at a station, and the like, for example. Further, flicker correction target object identification data included in each of these images, such as flicker correction target object identification data that is a rectangular frame defining a flicker target object, for example, is input as a data set (a training data set) for a learning process to the learning process execution unit (the first learning model generation unit) 171, and the learning process is performed.

That is, the learning process execution unit (the first learning model generation unit) 171 illustrated in FIG. 7 performs a learning process, using various images as the learning set including identification data (identification data such as a rectangular frame, for example) indicating which subject (object) is the flicker correction target object. That is, a “supervised learning process” is performed.

Through this learning process, the learning process execution unit (the first learning model generation unit) 171 illustrated in FIG. 7 generates a learning model (the first learning model) that enables execution of a process of detecting a subject (object) that might cause a flicker from among various images captured by the camera, or a flicker correction target object.

The flicker correction target object detection unit (the first learning model) 151 illustrated in FIG. 6 uses a learning model (the first learning model) generated through the learning process, to detect a subject image that might cause a flicker from among the images captured by the camera, or a flicker correction target object.

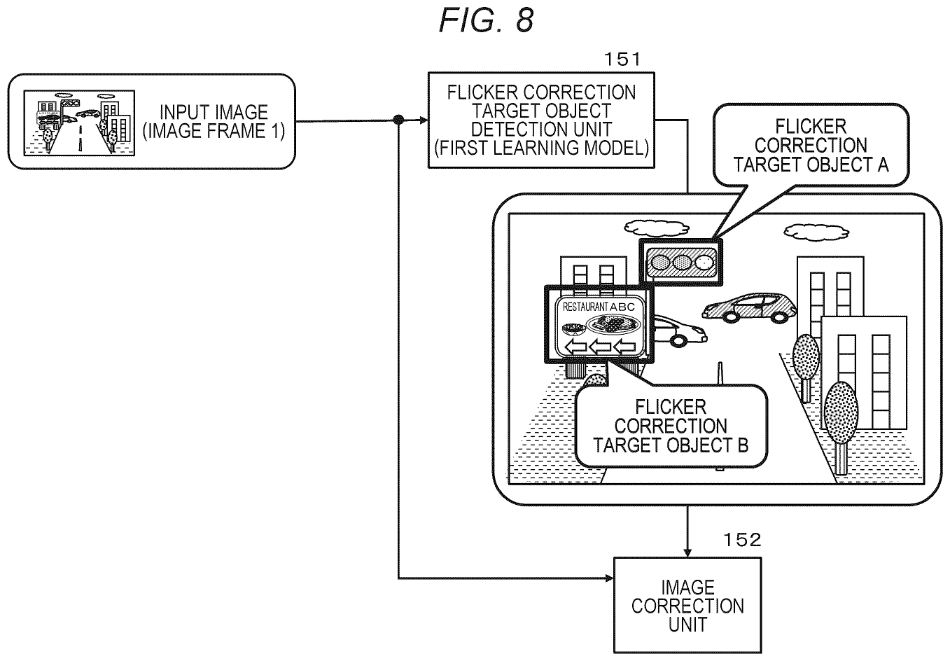

Referring now to FIG. 8, a specific example of the process to be performed by the flicker correction target object detection unit (the first learning model) 151 is described.

As illustrated in FIG. 8, the flicker correction target object detection unit (the first learning model) 151 receives an input of an input image (image frame 1) that is one of the captured images constituting a moving image captured by the camera.

The flicker correction target object detection unit (the first learning model) 151 uses the learning model (the first learning model), to detect a subject image that might cause a flicker, which is a flicker correction target object, from this one input image (image frame 1).

The example of the image illustrated in FIG. 8 is an example of the captured image described above with reference to FIG. 1.

There are two flicker correction target objects in this captured image. These are

$$\begin{matrix}a flicker correction target object A = traffic light , and \\ a flicker correction target object B = a display .\end{matrix}$$

The flicker correction target object detection unit (the first learning model) 151 uses the learning model (the first learning model), to detect these two flicker correction target objects A and B, and output information about the detection to the image correction unit 152.

Note that, specifically, the flicker correction target object detection information to be output by the flicker correction target object detection unit (the first learning model) 151 to the image correction unit 152 is coordinate information indicating the positions of flicker correction target object image regions in the captured image, shape information about the flicker correction target object image regions, and the like, and is information for enabling identification of the flicker correction target object image regions from the input image, for example.

The image correction unit 152 identifies the flicker correction target object image regions from the input image on the basis of the coordinate information about the flicker correction target object image regions, the shape information about the flicker correction target object image regions, and the like, which have been input from the flicker correction target object detection unit (the first learning model) 151, and performs flicker correction on the image regions.

That is, in this example, the image correction unit 152 performs flicker correction on the flicker correction target objects A and B detected by the flicker correction target object detection unit (the first learning model) 151.

As illustrated in FIG. 6, the image correction unit 152 receives an input of a plurality of consecutively captured images, and uses the plurality of consecutively captured images, to perform a flicker correction process only on the image regions of the flicker correction target objects A and B input from the flicker correction target object detection unit (the first learning model) 151, which is a process of eliminating flickers or an image correction process for reducing flickers.

As described above, the image regions to be the flicker correction targets are identified by the flicker correction target object detection unit (the first learning model) 151. Accordingly, the image correction unit 152 does not need to perform flicker analysis on the entire captured images, and can perform flicker correction only on the image regions of the flicker correction target objects A and B. As a result, a high-speed and high-accuracy flicker correction process can be performed.

Note that the flicker correction process to be performed on the image regions of the flicker correction target objects A and B by the image correction unit 152 is one of the processes described below, for example.

(Example 1 of a flicker correction process) A moving average is calculated among the latest several frames (three input image frames 1 to 3, for example) so that the luminance of the image regions of the flicker correction target objects becomes constant, and is set as the luminance of the image regions of the flicker correction target objects in each frame.

(Example 2 of a flicker correction process) A predetermined luminance (the maximum luminance, for example) among the latest several frames (three input image frames 1 to 3, for example) is selected so that the luminance of the image regions of the flicker correction target objects becomes constant, and is set as the luminance of the image regions of the flicker correction target objects in each frame.

(Example 3 of a flicker correction process) The image regions of the flicker correction target objects are replaced with images prepared in advance.

For example, any one of these processes is performed, to execute image correction on the image regions of the flicker correction target objects A and B detected from the captured image.

The corrected image generated through this process is an image in which flickers have been eliminated or reduced.

Note that there may be a case where the traffic light is actually in a blinking state, for example. In such a case, the image correction unit 152 preferably performs a process of optimizing the number of frames to which the above Examples 1 to 3 of a flicker correction process are applied (blinking of the traffic light is in cycles of one to two seconds) so as not to eliminate the blinking that is to be maintained.

Further, a flicker correction target object detection process to be performed by the flicker correction target object detection unit (the first learning model) 151 may be performed on all the frames of the image captured by the camera, but may be performed at predefined frame intervals too.

Furthermore, the flicker correction target object detection unit (the first learning model) 151 may be designed to track (follow), in the subsequent frames, the flicker correction target objects detected from a certain image frame, and identify the image regions of the flicker correction target objects through the tracking (following) process in the subsequent frames.

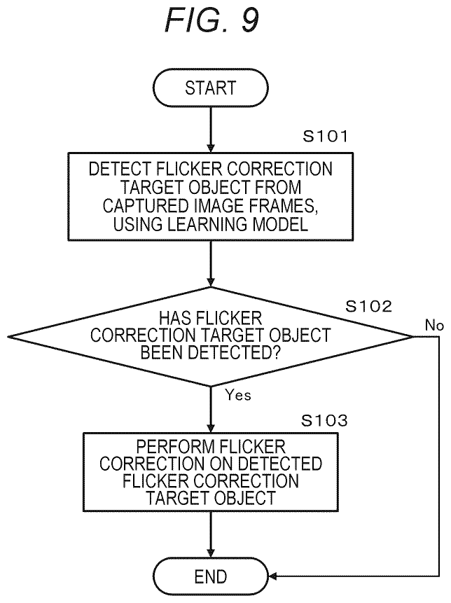

Referring next to a flowchart shown in FIG. 9, the sequence in a flicker correction process to be performed by the image processing device according to the present disclosure is described.

Note that the processes according to the flowchart shown in FIG. 9 can be performed by the flicker correction unit 150 according to a program stored in a storage unit of the image processing device. The flicker correction unit 150 includes a processor such as a CPU having a program execution function, for example, and can perform the processes according to the flow through a program execution process using the processor.

In the description below, the processes in the respective steps in the flowchart shown in FIG. 9 are explained.

Note that the flow shown in FIG. 9 is executed sequentially for the respective frames constituting a moving image captured by the camera. Alternatively, the flow may be executed at predetermined frame intervals.

### (Step S101)

First, in step S101, the flicker correction unit detects flicker correction target objects from captured image frames, using a learning model.

This process is a process to be performed by the flicker correction target object detection unit (the first learning model) 151 described with reference to FIGS. 6 and 8.

The flicker correction target object detection unit (the first learning model) 151 analyzes whether or not there is a subject image that might cause a flicker in each of the image frames constituting a moving image captured by the camera, or whether or not there is a flicker correction target object.

As described above, the flicker correction target object detection unit (the first learning model) 151 uses a learning model generated through a learning process beforehand as described above with reference to FIG. 7, to analyze whether or not there is a subject image that might cause a flicker in an image captured by the camera, or whether or not there is a flicker correction target object.

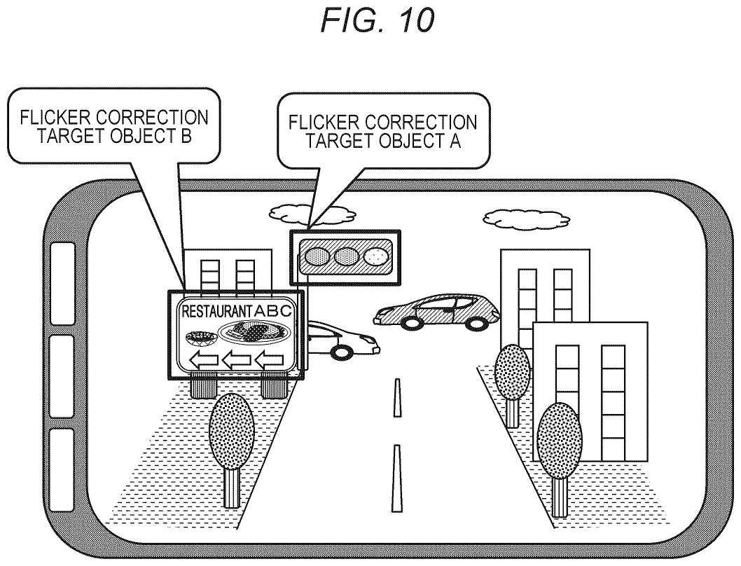

For example, as illustrated in FIG. 10, a process of detecting a subject image that might cause a flicker from one captured image is performed.

The example illustrated in FIG. 10 is an example in which the following two flicker correction target objects have been detected:

$$\begin{matrix}a flicker correction target object A = a traffic light , and \\ a flicker correction target object B = a display .\end{matrix}$$

### (Step S102)

Step S102 is a step of determining whether or not a flicker correction target object has been detected in the image analysis process in step S101.

If a flicker correction target object has been detected, the process moves on to step S103.

If any flicker correction target object has not been detected, on the other hand, the process comes to an end.

Note that, in a case where there is a subsequent processing target image frame, the processes in step S101 and the subsequent steps are performed for the image frame.

### (Step S103)

If a flicker correction target object has been detected in the flicker correction target object detection process in step S101, the process moves on to step S103.

In this case, the flicker correction unit 150 performs a flicker correction process on the detected flicker correction target object in step S103.

This process is a process to be performed by the image correction unit 152 illustrated in FIG. 6.

The image correction unit 152 performs flicker correction on the flicker correction target objects detected by the flicker correction target object detection unit (the first learning model) 151.

As illustrated in FIG. 6, the image correction unit 152 receives an input of a plurality of consecutively captured images, and uses the plurality of consecutively captured images, to perform a flicker correction process only on the image regions of the flicker correction target objects input from the flicker correction target object detection unit (the first learning model) 151, which is a process of eliminating flickers or an image correction process for reducing flickers.

As described above, the flicker correction process to be performed by the image correction unit 152 is one of the following processes, for example.

(Example 1 of a flicker correction process) A moving average is calculated among the latest several frames (three input image frames 1 to 3, for example) so that the luminance of the image regions of the flicker correction target objects becomes constant, and is set as the luminance of the image regions of the flicker correction target objects in each frame.

(Example 2 of a flicker correction process) A predetermined luminance (the maximum luminance, for example) among the latest several frames (three input image frames 1 to 3, for example) is selected so that the luminance of the image regions of the flicker correction target objects becomes constant, and is set as the luminance of the image regions of the flicker correction target objects in each frame.

(Example 3 of a flicker correction process) The image regions of the flicker correction target objects are replaced with images prepared in advance.

For example, one of these processes is performed, to execute image correction on the image regions of the flicker correction target objects detected from the captured image.

The corrected image generated through this process is an image in which flickers have been eliminated or reduced.

As described above, in the image processing device according to the present disclosure, the flicker correction target object detection unit 151 identifies the image regions to be the flicker correction targets by using a learning model, and the image correction unit 152 then performs flicker correction only on the image regions of the flicker correction target objects.

As these processes are performed, there is no need to perform a flicker analysis on the entire captured images, and a flicker correction process can be performed only on the image regions of the flicker correction target objects. Thus, a high-speed and high-accuracy flicker correction process can be performed.

### 4. (Second Embodiment) Configuration of and the Processes to Be Performed by a Flicker Correction Unit According to a Second Embodiment of the Present Disclosure

Next, the configuration of and the processes to be performed by a flicker correction unit according to a second embodiment of the present disclosure are described.

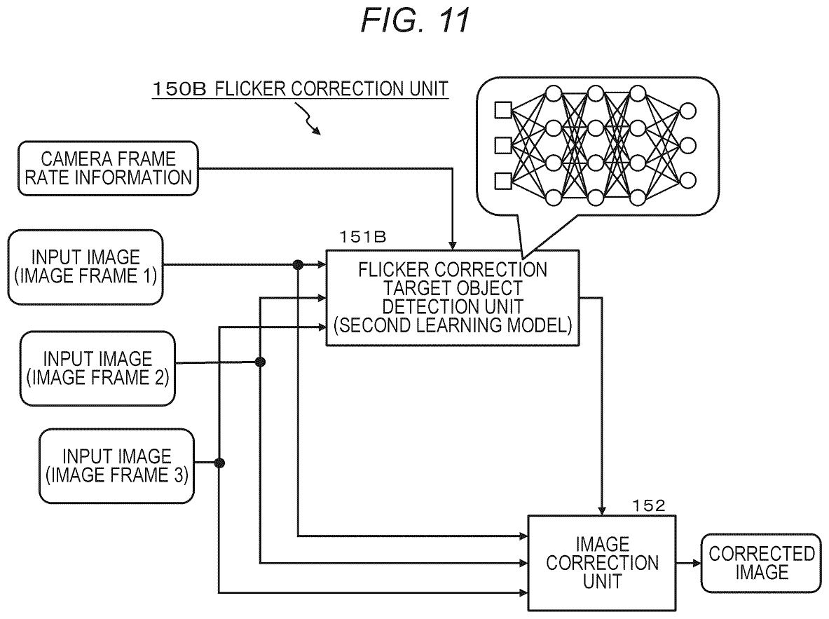

FIG. 11 is a diagram illustrating an example configuration of a flicker correction unit 150B according to the second embodiment of the present disclosure.

As illustrated in FIG. 11, the flicker correction unit 150B according to the second embodiment includes a flicker correction target object detection unit (a second learning model) 151B and an image correction unit 152.

The difference between the configuration according to the second embodiment and the flicker correction unit 150 according to the first embodiment described above with reference to FIG. 6 lies in that the flicker correction target object detection unit (the first learning model) 151 according to the first embodiment illustrated in FIG. 6 is replaced with the flicker correction target object detection unit (a second learning model) 151B illustrated in FIG. 11.

In the second embodiment, a process of detecting a flicker correction target object is performed, using a learning model (the second learning model) different from the learning model (the first learning model) used in the first embodiment described above with reference to FIGS. 6 to 11.

As illustrated in FIG. 11, the flicker correction target object detection unit (the second learning model) 151B of the flicker correction unit 150B according to the second embodiment receives an input of a plurality of consecutive image frames constituting a moving image captured by a camera.

Note that, in the configuration illustrated in FIG. 11, three consecutively captured frames are input. However, the number of the captured frames to be input is not limited to three, and a larger number of consecutive image frames may be input.

The flicker correction target object detection unit (the second learning model) 151B of the flicker correction unit 150B according to the second embodiment illustrated in FIG. 11 receives an input of a plurality of consecutively captured image frames, and performs a flicker correction target object detection process with a higher accuracy.

Also, as illustrated in FIG. 11, the flicker correction target object detection unit (the second learning model) 151B of the flicker correction unit 150B according to the second embodiment also receives an input of camera frame rate information.

The camera that captures a moving image is not necessarily a camera with a frame rate of 30 fps at which 30 images are captured in one second, for example, but may be a camera in which some other frame rate can be set, such as a frame rate of 60 fps at which 60 images are captured in one second, a frame rate of 120 fps at which 120 images are captured in one second, or the like.

The flicker correction target object detection unit (the second learning model) 151B of the flicker correction unit 150B according to the second embodiment illustrated in FIG. 11 performs a process of detecting an optimal flicker correction target object in accordance with these various camera frame rates.

The flicker correction target object detection unit (the second learning model) 151B of the flicker correction unit 150B according to the second embodiment illustrated in FIG. 11 receives an input of a plurality of consecutively captured image frames constituting a moving image captured by the camera, and the camera frame rate information, inputs these pieces of information to the second learning model generated beforehand, and analyzes whether or not there is a subject image that might cause a flicker, or whether or not there is a flicker correction target object.

In a case where a flicker correction target object is detected by the flicker correction target object detection unit (the second learning model) 151B, the image correction unit 152 performs a flicker correction process for eliminating or reducing flickers.

The flicker correction target object detection unit (the second learning model) 151B inputs the plurality of consecutively captured image frames and the camera frame rate information to a learning model (the second learning model) generated through a learning process performed in advance, and analyzes whether or not there is a subject image that might cause a flicker from the image captured by the camera, or whether there is a flicker correction target object.

The second learning model to be used by the flicker correction target object detection unit (the second learning model) 151B is also a learning model generated as a result of machine learning to which an algorithm such as a deep neural network (DNN) that is a multilayer neural network, for example, a convolutional neural network (CNN), or a recurrent neural network (RNN) is applied.

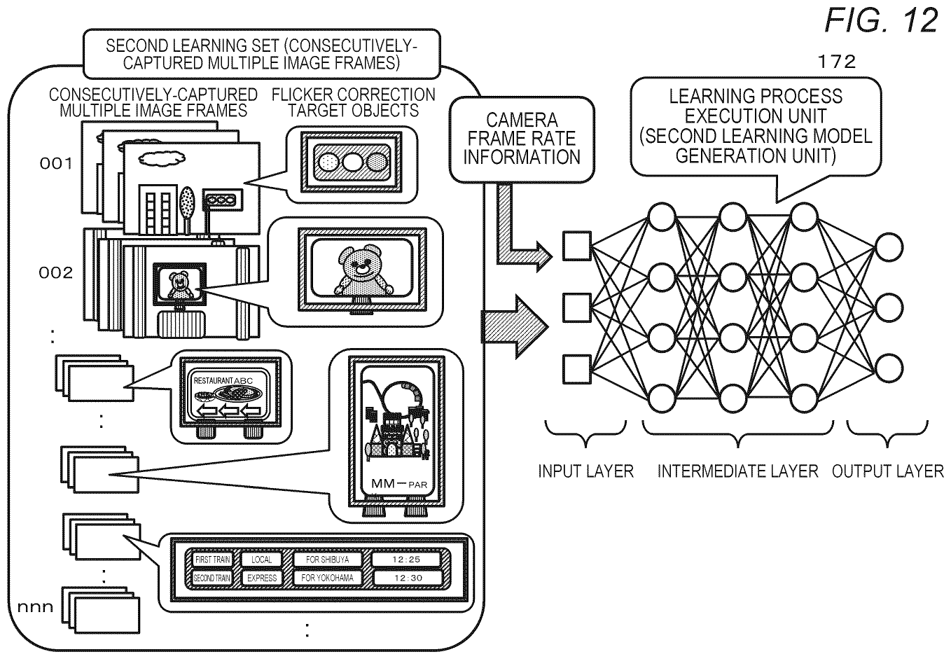

Referring now to FIG. 12, the second learning model that is used by the flicker correction target object detection unit (the second learning model) 151B is described.

A learning process execution unit (a learning model generation unit) 172 illustrated in FIG. 12 receives an input of a “second learning set (a plurality of image frames)” including consecutively captured images obtained by imaging various subjects and the camera frame rate information about the camera frame rate at which these images have been captured, and performs a learning process.

The input “second learning set” is a learning set that includes a plurality of consecutively captured image frames (three frames, for example) constituting a moving image captured by the camera, and identification information about the flicker correction target object included in each of the images.

The input images are an image including a display, an image including a traffic light, an image including an electric bulletin board at a station, and the like, for example. Further, flicker correction target object identification data included in each of these images, such as flicker correction target object identification data that is a rectangular frame defining a flicker target object, for example, is input as a data set (a training data set) for a learning process to the learning process execution unit (a second learning model generation unit) 172, and the learning process is performed.

That is, the learning process execution unit (the second learning model generation unit) 172 illustrated in FIG. 12 performs a learning process in which various consecutively-captured image frames including identification data (identification data such as a rectangular frame, for example) indicating which subject (object) is a flicker correction target object, and the camera frame rate information about the camera frame rate at which these image have been captured are input. That is, a “supervised learning process” is performed.

Note that the learning process may be performed for each camera frame rate among a plurality of different camera frame rates, to generate a plurality of different learning models, for example. For example, a plurality of learning models as listed below may be generated:
(a) a second learning model a that is compatible with a camera frame rate of 30 fps, and is generated through a learning process using consecutive image frames captured at a camera frame rate of 30 fps;
(b) a second learning model b that is compatible with a camera frame rate of 60 fps, and is generated through a learning process using consecutive image frames captured at a camera frame rate of 30 fps; and
(c) a second learning model c that is compatible with a camera frame rate of 30 fps, and is generated through a learning process using consecutive image frames captured at a camera frame rate of 120 fps.

In a case where a plurality of such learning models compatible with these camera frame rates is generated, a learning model to be used is selected in accordance with the camera frame rate when the learning model is used.

Alternatively, instead of a plurality of learning models compatible with frame rates like the above (a) to (c), one learning model compatible with a plurality of camera frame rates may be generated, with those learning models not being distinguished from one another.

In a case where one learning model compatible with a plurality of camera frame rates is generated, a camera frame rate is input when the learning model is used, the processing mode is changed on the learning model side in accordance with the input camera frame rate, and an analysis processing result corresponding to each frame rate is output.

In any case, it is possible to detect a subject image that might cause a flicker in accordance with the frame rate of the camera, or detect a flicker correction target object through a process using the learning model.

Through this learning process, the learning process execution unit (the second learning model generation unit) 172 illustrated in FIG. 12 generates a learning model (the second learning model) that detects a subject (object) that might cause a flicker from among images captured by the camera, or a flicker correction target object, in accordance with the frame rate of the camera.

The flicker correction target object detection unit (the second learning model) 151B illustrated in FIG. 11 receives an input of a plurality of consecutively captured images constituting a moving image captured by the camera and the frame rate information about the camera that has captured the images, and detects a flicker correction target object, using the learning model (the second learning model) generated through the learning process illustrated in FIG. 12.

By performing such a process, it becomes possible to perform a flicker correction target object detection process with a higher accuracy.

Specifically, a traffic light is sometimes put into a blinking state, instead of a lighted state, for example. A pattern in which the yellow light blinks at intervals of one to two seconds, or a pattern in which the red light blinks may be set. This blinking can be recognized with the naked eye.

However, in a configuration in which a flicker correction target object is detected from one image as in the first embodiment described above, the flicker correction target object detection unit (the first learning model) 151 illustrated in FIG. 6 detects the traffic light as a flicker correction target object. After that, the image correction unit 152 performs flicker correction.

However, when the red light of the traffic light is in a blinking state, for example, if the image correction unit 152 performs flicker correction, the blinking state might not be reproduced in some cases.

For example, the above-described (Example 1 of a flicker correction process) is adopted.

That is, in the (Example 1 of a flicker correction process), a moving average is calculated among the latest several frames (three input image frames 1 to 3, for example) so that the luminance of the image regions of the flicker correction target objects becomes constant, and is set as the luminance of the image regions of the flicker correction target objects in each frame.

When such flicker correction is performed, a blinking state might not be reproduced in the reproduced moving image after the flicker correction.

The second learning model that is used in the second embodiment is a learning model for not causing such a problem.

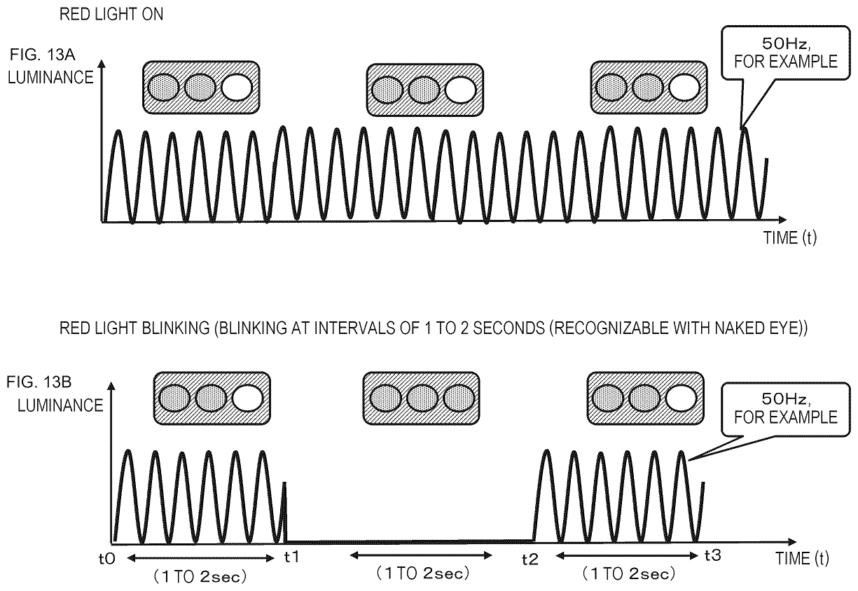

Referring now to FIG. 13, a lighted state of a traffic light and a luminance change mode in a blinking state are described.

FIG. 13(A) illustrates a lighted state of the red light. FIG. 13(B) illustrates a blinking state.

In the (A) red light lighted state, a luminance change is repeated at 50 Hz, for example.

In the (B) red light blinking state, on the other hand, a lighted period is set with a luminance change at 50 Hz, and a non-lighted period is set in a non-lighted state without any luminance change. The lighted period and the non-lighted period are set as periods of about one to two seconds, for example.

Since the first learning model described in the first embodiment is designed to detect flicker correction target objects from one image, it is not possible to distinguish between the (A) lighted state and the (B) blinking state illustrated in FIG. 13. However, the second learning model that is used in the second embodiment can distinguish between the (A) lighted state and the (B) blinking state illustrated in FIG. 13.

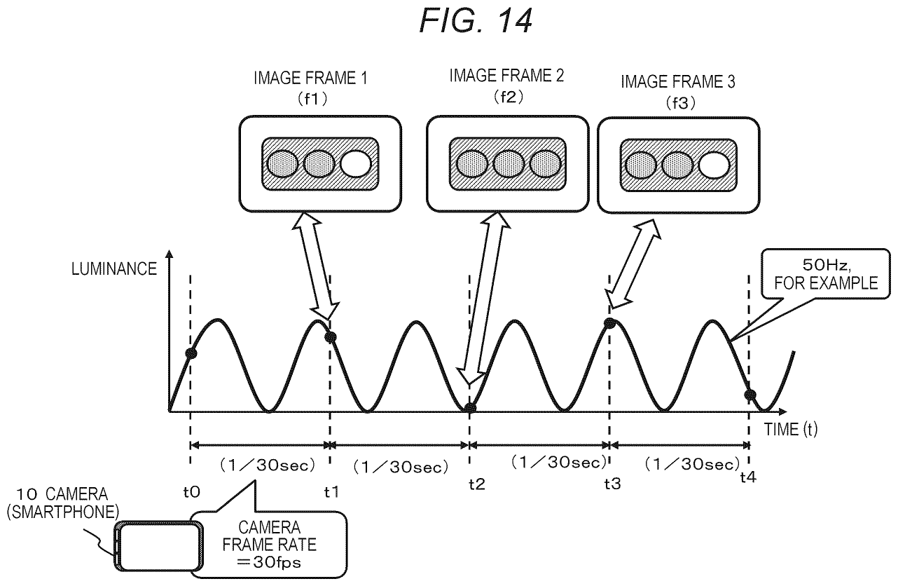

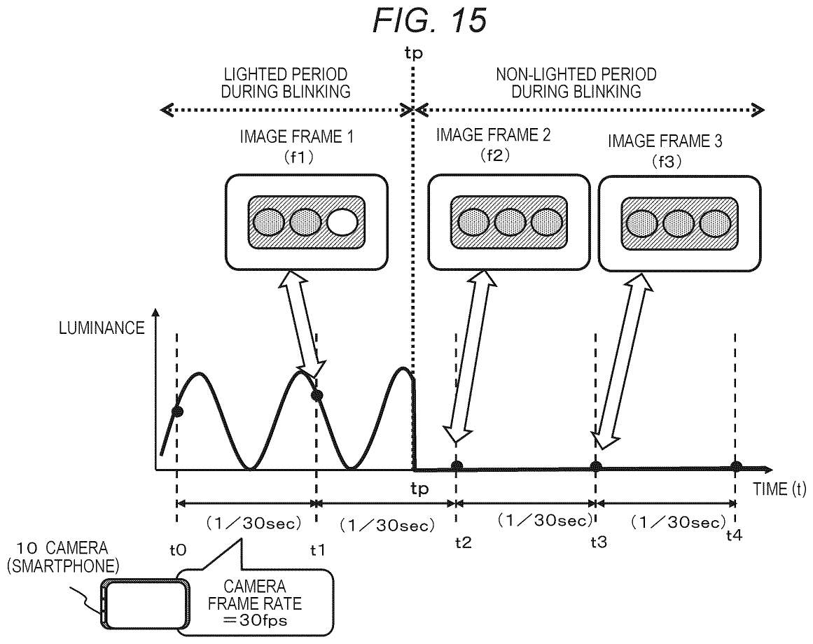

The reason for this is now described with reference to FIGS. 14 and 15.

FIG. 14 illustrates a luminance change pattern of the red light in a case where the red light of a traffic light is in a lighted state. The red light repeats a luminance change at 50 Hz, for example.

In this state, the camera 10 captures a moving image. The frame rate of the camera is 30 fps.

The image frame 1 (f1) is captured at time t1. After that, the image frame 2 (f2) is captured at time t2, and the image frame 3 (f3) is captured at imaging time t3.

The luminance of the red light of the traffic light captured in these images (the image frames f1 to f3) changes as illustrated in the drawing.

The image frame 1 (f1) at time t1 has a high luminance, the image frame 2 (f2) at time t2 has a low luminance, and the image frame 3 (f3) at time t3 has a high luminance.

In this manner, the high luminance and the low luminance are repeated during 2/30 sec. This is a proof that the red light indicates luminance changes in short cycles, and it can be determined that the red light is in a lighted state.

Next, an example of luminance changes of the red light in a case where the red light of the traffic light is in a blinking state is described with reference to FIG. 15. The period before time (tp) shown in FIG. 15 is a lighted period during which blinking is being performed, and the period after time (tp) is a non-lighted period in a blinking state.

A luminance change is repeated at 50 Hz during the lighted period. During the non-lighted period, a non-lighted state continues.

In this state, the camera 10 captures a moving image. The frame rate of the camera is 30 fps.

The image frame 1 (f1) is captured at time t1. After that, the image frame 2 (f2) is captured at time t2, and the image frame 3 (f3) is captured at imaging time t3.

The luminance of the red light of the traffic light captured in these images (the image frames f1 to f3) changes as illustrated in the drawing.

The image frame 1 (f1) at time t1 has a high luminance,
the image frame 2 (f2) at time t2 has the lowest luminance, and
the image frame 3 (f3) at time t3 has the lowest luminance.

In this manner, it can be determined that the lowest luminance continues at time t2 and time t3. As a result, it can be determined that the red light has shifted to a non-lighted state.

Note that, from this aspect alone, it is difficult to determine whether the red light is in a blinking state, or whether the red light has simply shifted to a non-lighted state. However, it becomes possible to perform a process of excluding the image(s) of the traffic light in this state from the flicker correction targets.

As described above, the second learning model that is used by the flicker correction target object detection unit (the second learning model) 151B of the flicker correction unit 150B according to the second embodiment illustrated in FIG. 11 can distinguish the lighted state of the signal light from the other states (the blinking state and the non-lighted state) by analyzing a plurality of consecutively captured images.

As a result, it becomes possible to perform a process of not selecting a traffic light image in a blinking state as a flicker correction target object, for example.

Further, the flicker correction target object detection unit (the second learning model) 151B of the flicker correction unit 150B according to the second embodiment illustrated in FIG. 11 is designed to receive not only an input of consecutively captured images but also an input of the frame rate information about the camera, and detect a flicker correction target object in accordance with the frame rate information about the camera.

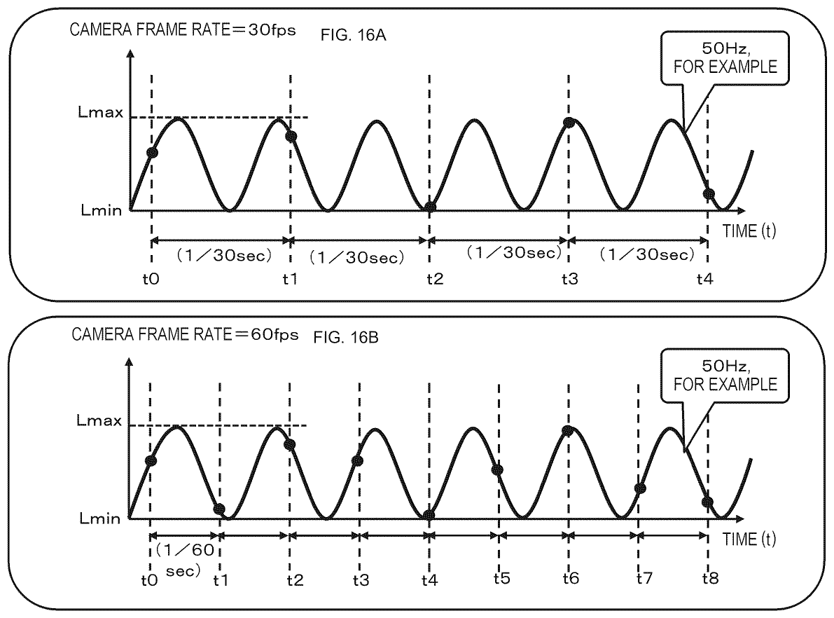

Referring now to FIG. 16, this aspect of the configuration is described.

FIG. 16 illustrates luminance changes (black circles) of the traffic light in captured images in a case where images of the lighted state of the traffic light showing luminance changes at 50 Hz have been captured by cameras having different frame rates.

$$Camera frame rate = 30 fps \qquad ( a )$$

$$Camera frame rate = 60 fps \qquad ( b )$$

In both of the cases (a) and (b), luminance changes (black circles) of the traffic light in the captured images occur.

However, in a case where such captured images are reproduced, and the captured images are reproduced, the luminance change pattern varies with the frame rates of the cameras.

The flicker correction target object detection unit (the second learning model) 151B of the flicker correction unit 150B according to the second embodiment illustrated in FIG. 11 selects a flicker correction target object in accordance with the frame rate information about the camera.

Specifically, in a case where the frame rate of the camera is high, a process of making the criteria of selecting flicker correction target objects stricter than in a case where the frame rate of the camera is low is performed. For example, in a case where the frame rate of the camera is high, when the luminance change width among consecutively captured images to be input is equal to or smaller than a threshold, a process of not selecting any flicker correction target object is performed.

Note that, as described above, the learning process execution unit (the second learning model generation unit) 172 illustrated in FIG. 12 may be designed to generate a plurality of different learning models for a plurality of different camera frame rates. In this case, the flicker correction target object detection unit (the second learning model) 151B of the flicker correction unit 150B illustrated in FIG. 11 selects the learning model to be used, in accordance with the camera frame rate at the time of use of the learning model.

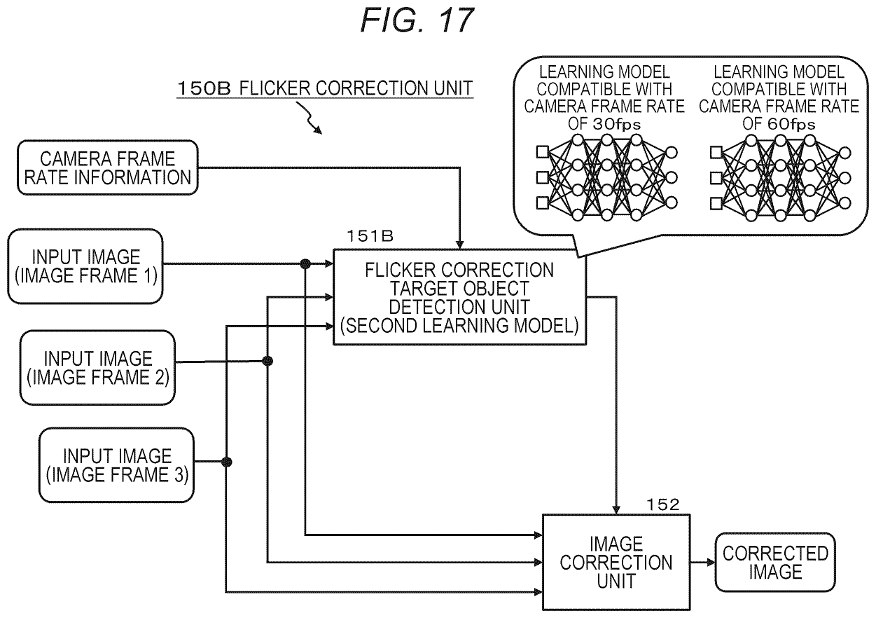

For example, the configuration is as illustrated in FIG. 17.

The flicker correction target object detection unit (the second learning model) 151B of the flicker correction unit 150B illustrated in FIG. 17 includes
a learning model compatible with a camera frame rate of 30 fps, and
a learning model compatible with a camera frame rate of 60 fps.

The two learning models compatible with these camera frame rates are included.

The flicker correction target object detection unit (the second learning model) 151B selects the learning model to be used, in accordance with the input camera frame rate information, and uses the selected learning model.

Note that, instead of a plurality of learning models compatible with frame rates as described above, one learning model compatible with a plurality of camera frame rates may be generated, with those learning models not being distinguished from one another.

In a case where one learning model compatible with a plurality of camera frame rates is generated, the flicker correction target object detection unit (the second learning model) 151B changes the processing mode in accordance with the input camera frame rate information, and outputs an analysis processing result corresponding to each frame rate.

In any case, it is possible to detect a subject image that might cause a flicker in accordance with the frame rate of the camera or detect a flicker correction target object through a process using a learning model, and output a detection result to the image correction unit 152.

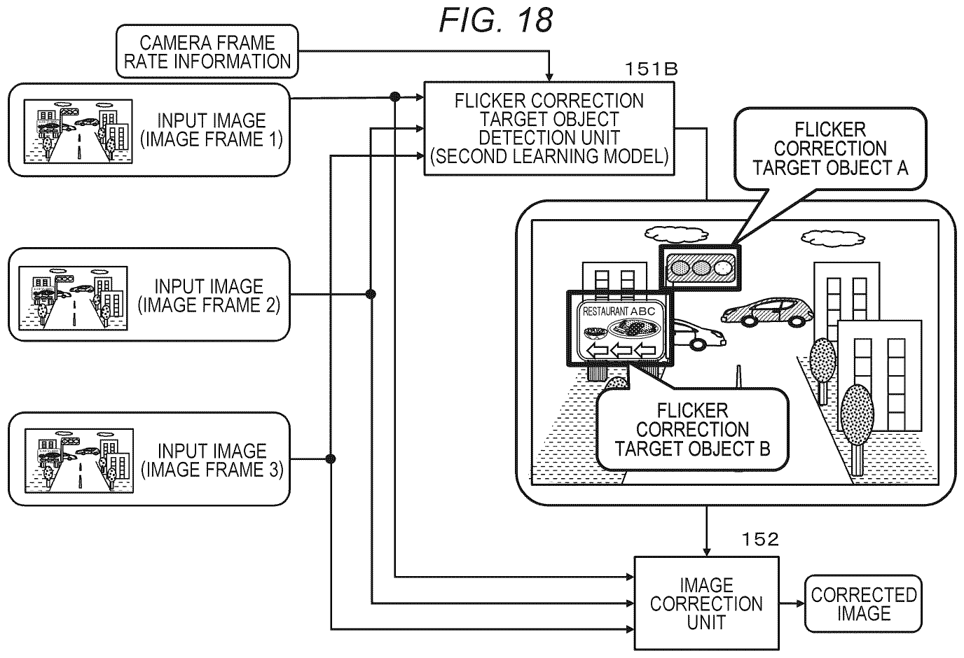

A specific example of a process to be performed by the flicker correction target object detection unit (the second learning model) 151B of the flicker correction unit 150B according to the second embodiment illustrated in FIG. 11 and FIG. 17 is now described with reference to FIG. 18.

As illustrated in FIG. 18, the flicker correction target object detection unit (the second learning model) 151B receives an input of a plurality of consecutively captured images (three consecutively captured image frames, for example) constituting a moving image captured by the camera, and the frame rate information (30 fps, 60 fps, or the like, for example) about the camera that has captured these images.

The flicker correction target object detection unit (the second learning model) 151B inputs the plurality of consecutively captured images that have been input and the frame rate information about the camera to the second learning model, and detects a subject image that might cause a flicker, or a flicker correction target object.

The example of the image illustrated in FIG. 18 is an example of the captured image described above with reference to FIG. 1.

There are two flicker correction target objects in this captured image. These are

$$\begin{matrix}a flicker correction target object A = traffic light , and \\ a flicker correction target object B = a display .\end{matrix}$$

The flicker correction target object detection unit (the second learning model) 151B uses the learning model (the second learning model), to detect these two flicker correction target objects A and B, and output information about the detection to the image correction unit 152.

Note that, specifically, the flicker correction target object detection information to be output by the flicker correction target object detection unit (the second learning model) 151B to the image correction unit 152 is coordinate information indicating the positions of flicker correction target object image regions in the captured image, shape information about the flicker correction target object image regions, and the like, and is information for enabling identification of the flicker correction target object image regions from the input image, for example.

The image correction unit 152 performs flicker correction on the flicker correction target objects A and B detected by the flicker correction target object detection unit (the first learning model) 151.

As illustrated in FIGS. 11 and 17, the image correction unit 152 receives an input of a plurality of consecutively captured images, and uses the plurality of consecutively captured images, to perform a flicker correction process only on the image regions of the flicker correction target objects A and B input from the flicker correction target object detection unit (the second learning model) 151B, which is a process of eliminating flickers or an image correction process for reducing flickers.

As described above, the image regions to be the flicker correction targets are identified by the flicker correction target object detection unit (the second learning model) 151B. Accordingly, the image correction unit 152 does not need to perform flicker analysis on the entire captured images, and can perform flicker correction only on the image regions of the flicker correction target objects A and B. As a result, a high-speed and high-accuracy flicker correction process can be performed.

Note that the flicker correction process to be performed on the image regions of the flicker correction target objects A and B by the image correction unit 152 is one of the processes described below, for example, as described in the foregoing first embodiment.

(Example 1 of a flicker correction process) A moving average is calculated among the latest several frames (three input image frames 1 to 3, for example) so that the luminance of the image regions of the flicker correction target objects becomes constant, and is set as the luminance of the image regions of the flicker correction target objects in each frame.

(Example 2 of a flicker correction process) A predetermined luminance (the maximum luminance, for example) among the latest several frames (three input image frames 1 to 3, for example) is selected so that the luminance of the image regions of the flicker correction target objects becomes constant, and is set as the luminance of the image regions of the flicker correction target objects in each frame.

(Example 3 of a flicker correction process) The image regions of the flicker correction target objects are replaced with images prepared in advance.

For example, any one of these processes is performed, to execute image correction on the image regions of the flicker correction target objects A and B detected from the captured image.

The corrected image generated through this process is an image in which flickers have been eliminated or reduced.

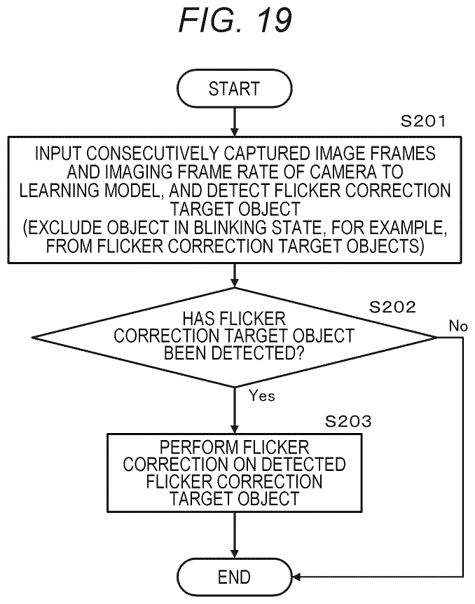

Referring next to a flowchart shown in FIG. 19, the sequence in a flicker correction process to be performed by the flicker correction unit 150B according to the second embodiment is described.

In the description below, the processes in the respective steps in the flowchart shown in FIG. 19 are explained.

Note that the flow shown in FIG. 19 is executed sequentially for the respective frames constituting a moving image captured by the camera. Alternatively, the flow may be executed at predetermined frame intervals.

### (Step S201)

First, in step S201, the flicker correction unit detects flicker correction target objects from captured image frames, using a learning model (the second learning model).

This process is a process to be performed by the flicker correction target object detection unit (the second learning model) 151B illustrated in FIGS. 11 and 17.

The flicker correction target object detection unit (the second learning model) 151B inputs a plurality of consecutively captured images (three consecutively captured image frames) constituting a moving image captured by the camera and the frame rate information (such as 30 fps or 60 fps, for example) about the camera that has captured these images to the second learning model, and detects a subject image that might cause a flicker, or a flicker correction target object.

In this process using the second learning model, an object such as a traffic light in a blinking state is not selected as a flicker correction target object, for example. Further, in a case where the camera frame rate is higher than a prescribed threshold, such as 60 fps, any object having a luminance change width equal to or smaller than a prescribed threshold as a luminance change object among the plurality of consecutively captured images that have been input is not selected as a flicker correction target object either.

### (Step S202)

Step S202 is a step of determining whether or not a flicker correction target object has been detected.

If a flicker correction target object has been detected, the process moves on to step S203.

If any flicker correction target object has not been detected, on the other hand, the process comes to an end.

Note that, in a case where there is a subsequent processing target image frame, the processes in step S201 and the subsequent steps are performed for the image frame.

### (Step S203)

If a flicker correction target object has been detected in the flicker correction target object detection process in step S201, the process moves on to step S203.

In this case, the flicker correction unit 150 performs a flicker correction process on the detected flicker correction target object in step S203.

This process is a process to be performed by the image correction unit 152 illustrated in FIG. 11 and FIG. 17.

The image correction unit 152 performs flicker correction on the flicker correction target objects detected by the flicker correction target object detection unit (the second learning model) 151B.

The image correction unit 152 receives an input of a plurality of consecutively captured images, and uses the plurality of consecutively captured images, to perform a flicker correction process only on the image regions of the flicker correction target objects input from the flicker correction target object detection unit (the second learning model) 151B, which is a process of eliminating flickers or an image correction process for reducing flickers.

As described above, the flicker correction process to be performed by the image correction unit 152 is one of the following processes, for example.

(Example 1 of a flicker correction process) A moving average is calculated among the latest several frames (three input image frames 1 to 3, for example) so that the luminance of the image regions of the flicker correction target objects becomes constant, and is set as the luminance of the image regions of the flicker correction target objects in each frame.

(Example 2 of a flicker correction process) A predetermined luminance (the maximum luminance, for example) among the latest several frames (three input image frames 1 to 3, for example) is selected so that the luminance of the image regions of the flicker correction target objects becomes constant, and is set as the luminance of the image regions of the flicker correction target objects in each frame.

(Example 3 of a flicker correction process) The image regions of the flicker correction target objects are replaced with images prepared in advance.

For example, one of these processes is performed, to execute image correction on the image regions of the flicker correction target objects detected from the captured image.

The corrected image generated through this process is an image in which flickers have been eliminated or reduced.

As described above, in the image processing device according to the second embodiment, the flicker correction target object detection unit 151B detects a flicker correction target object by inputting a plurality of consecutively captured image frames and the camera frame rate information to the second learning model.

As such a flicker correction target object detection process is performed, more accurate detection of flicker correction target objects is performed.

Furthermore, as in Example 1, the image correction unit 152 can perform flicker correction only on the image regions of the flicker correction target objects detected by the flicker correction target object detection unit 151B, and there is no need to perform flicker analysis on the entire captured images. Thus, a high-speed and high-accuracy flicker correction process can be performed.

### 5. (Third Embodiment) Configuration of and the Processes to Be Performed by a Flicker Correction Unit According to a Third Embodiment of the Present Disclosure

Next, the configuration of and the processes to be performed by a flicker correction unit according to a third embodiment of the present disclosure are described.

In a case where the luminance change cycle of a flicker correction target object is a multiple of the camera frame rate, for example, an image of the flicker correction target object in the lowest luminance state might be captured in all the image frames consecutively captured by the camera.

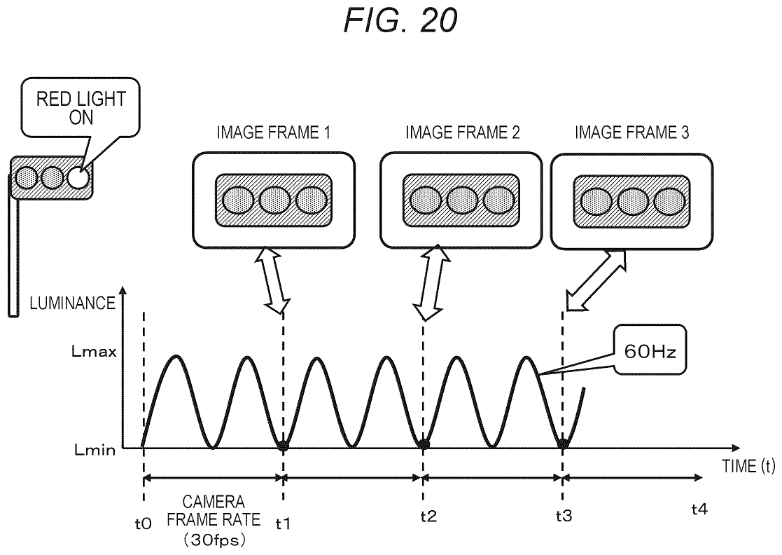

A specific example will be described with reference to FIG. 20.

FIG. 20 illustrates a luminance change pattern of the red light in a case where the red light of a traffic light is in a lighted state.

As illustrated in the drawing, the luminance of the red light periodically repeats the luminance levels of the maximum luminance (Lmax) and the minimum luminance (Lmin). Here, it is assumed that the luminance change cycle of the red light in a lighted state is “60 Hz”.

The camera frame rate is “30 fps”.

That is, the luminance change cycle of the flicker correction target object (the red light of the traffic light) is a multiple of the camera frame rate.

When capturing of a moving image by the camera is started with such settings at time t1 in the graph shown in FIG. 20, for example, images of the red light with the lowest luminance (Lmin) are captured at all the image frame capturing timings of times t1, t2, and t3, as illustrated in the drawing.

In a case where all the consecutively captured image frames are images with the lowest luminance (Lmin) in this manner, a correction error will occur even if flicker correction is performed.

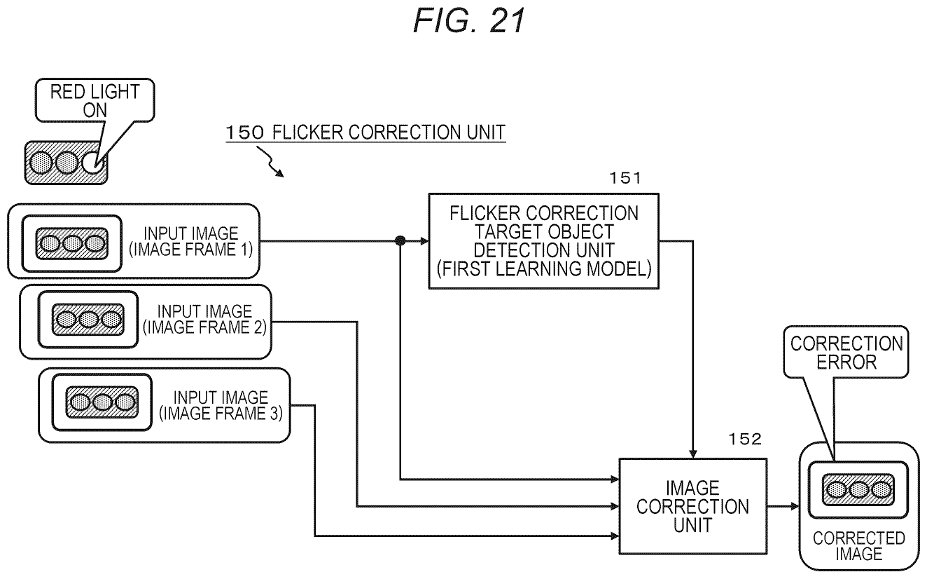

That is, even if the image correction unit 152 of the flicker correction unit 150 performs flicker correction such as a luminance averaging process using three images, as illustrated in FIG. 21, the portion of the red light in the corrected image is in a completely dark state, and an image different from the actual lighted state is generated.

The third embodiment is an embodiment that solves such a flicker correction error.

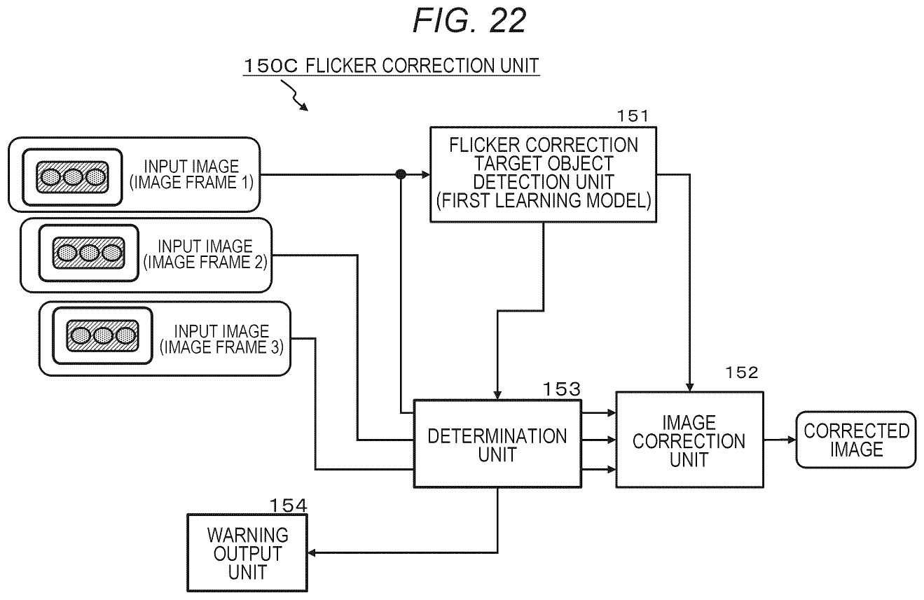

FIG. 22 illustrates the configuration of a flicker correction unit 150C according to the third embodiment. The flicker correction unit 150C illustrated in FIG. 22 has a configuration in which a determination unit 153 and a warning output unit 154 are added to the configuration of the flicker correction unit 150 according to the first embodiment described above with reference to FIG. 6.

The determination unit 153 receives an input of a plurality of consecutively captured image frames captured by the camera, and further receives an input of detected flicker correction target object information from the flicker correction target object detection unit (the first learning model) 151.

The determination unit 153 analyzes the luminance change state of a flicker correction target object detected by the flicker correction target object detection unit (the first learning model) 151.

That is, the luminance change state of the flicker correction target object among the plurality of consecutively captured image frames that have been input is analyzed.

As a result of the analysis process, in a case where there are no luminance changes in the flicker correction target object, and the luminance is equal to or lower than a prescribed threshold (a luminance close to a non-lighted state, for example), the warning output unit 154 is made to output a warning to the user who is conducting the image capturing.

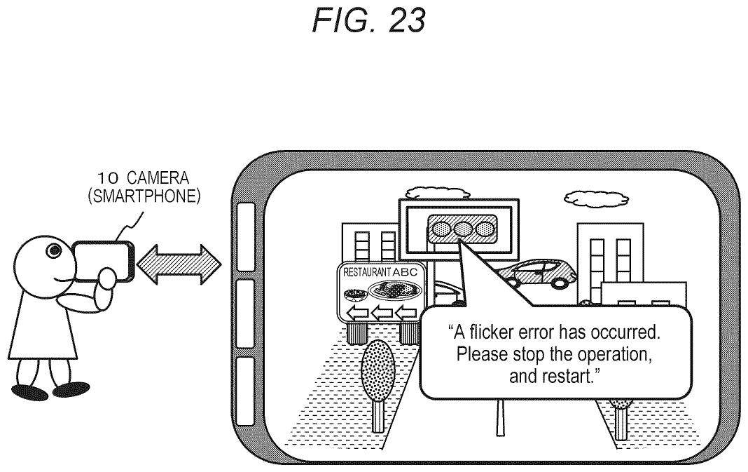

For example, a warning as illustrated in FIG. 23 is output.

FIG. 23 illustrates an example in which the warning message shown below is displayed as a message to the user who is capturing an image with a camera 10.

“A flicker correction error has occurred. Please stop the operation, and restart.”

Checking this message, the user conducts a process of stopping the image capturing, and then conducts a process of starting image capturing again.

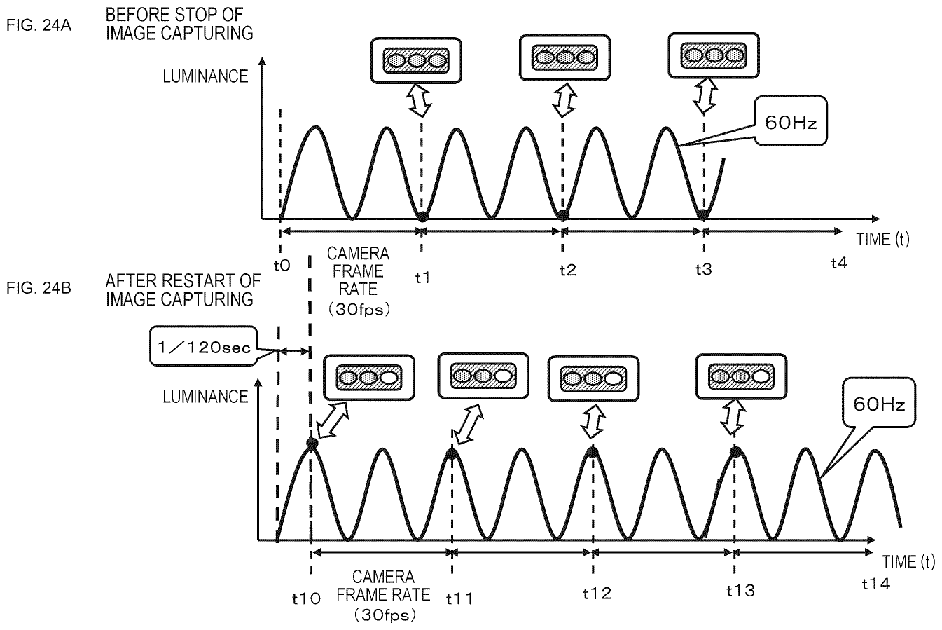

As the image capturing is restarted in this manner, the timing of image capturing by the camera 10 is shifted, and the settings change as illustrated in FIG. 24, for example.

FIG. 24(a) illustrates the image capturing state before the image capturing is stopped by the user, which is the state described above with reference to FIG. 20. That is, as illustrated in the drawing, an image of the red light with the lowest luminance (Lmin) is captured at all the image frame capturing timings of time t1, t2, and t3.

FIG. 24(b) illustrates an example of the imaging capturing state after the imaging capturing is restarted at time t10 after the stop of the imaging capturing by the user. In the settings illustrated in FIG. 24(b), an image of the red light with the highest luminance (Lmax) is captured at all the image frame capturing timings of times t10, t11, t12, and t13.

When such captured images are obtained, the eventual corrected image can also be an image with the highest luminance (Lmax) in the red light portion of the traffic light.

Note that the configuration described with reference to FIGS. 22 to 24 is an example of a device having a component that requests the user to shift the image capturing timings. However, a configuration in which the image capturing timings are automatically shifted may be designed.

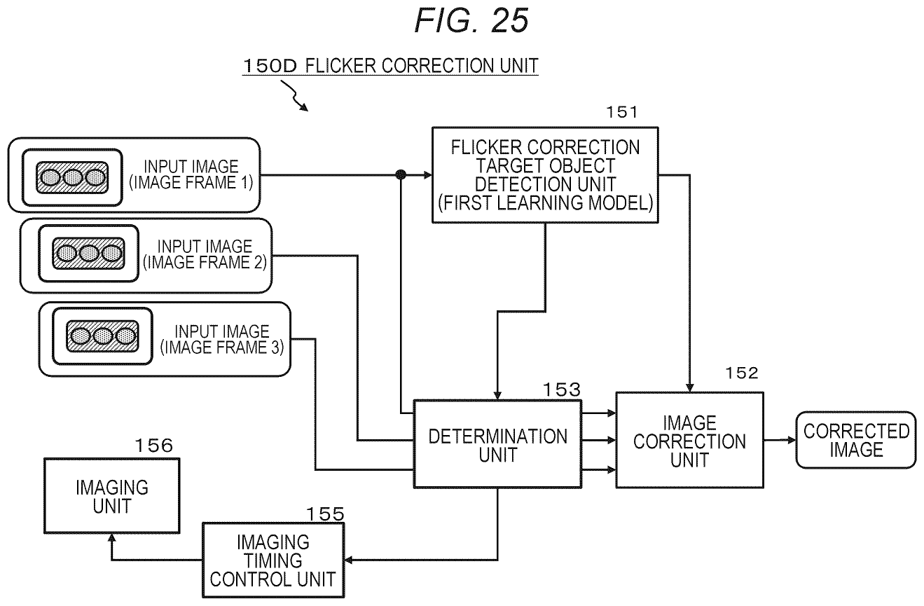

For example, the configuration is as illustrated in FIG. 25.

A flicker correction unit 150D illustrated in FIG. 25 has a configuration in which a determination unit 153 and an imaging timing control unit 155 are added to the configuration of the flicker correction unit 150 according to the first embodiment described above with reference to FIG. 6. Note that the imaging timing control unit 155 controls an imaging unit 156 to perform a process of changing the timing to capture a moving image.

The determination unit 153 receives an input of a plurality of consecutively captured image frames captured by the camera, and further receives an input of detected flicker correction target object information from the flicker correction target object detection unit (the first learning model) 151.

The determination unit 153 analyzes the luminance change state of a flicker correction target object detected by the flicker correction target object detection unit (the first learning model) 151.

That is, the luminance change state of the flicker correction target object among the plurality of consecutively captured image frames that have been input is analyzed.

As a result of the analysis process, in a case where there are no luminance changes in the flicker correction target object, and the luminance is equal to or lower than a prescribed threshold (a luminance close to a non-lighted state, for example), the imaging timing control unit 155 is made to perform the process of changing the timing to capture a moving image.

The imaging timing control unit 155 controls the imaging unit 156 to perform the process of changing the timing to capture a moving image.

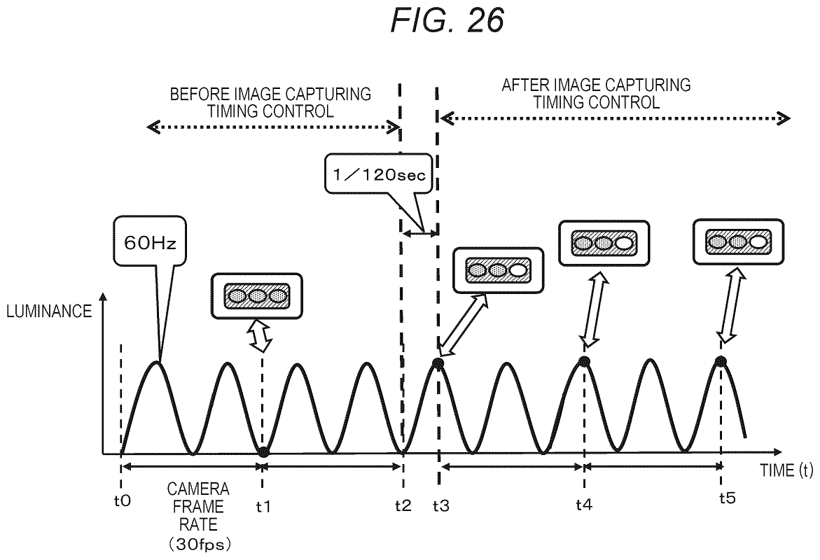

FIG. 26 illustrates an example of the process of changing the moving image capturing timing to be performed by the imaging timing control unit 155.

The period before time t2 is the period before the process of changing the moving image capturing timing. This state is the state described above with reference to FIG. 20. That is, as illustrated in the drawing, an image of the red light with the lowest luminance (Lmin) is captured at all the image frame capturing timings before time t1.

Here, the imaging timing control unit 155 controls the imaging unit 156 to perform the process of changing the timing to capture a moving image.

The image capturing at time t2 is stopped, and image capturing is restarted at time t3. As a result, an image of the red light with the highest luminance (Lmax) is captured at all the image frame capturing timings of times t3, t4, and t5, which are newly set image capturing timings.

When such captured images are obtained, the eventual corrected image can also be an image with the highest luminance (Lmax) in the red light portion of the traffic light.

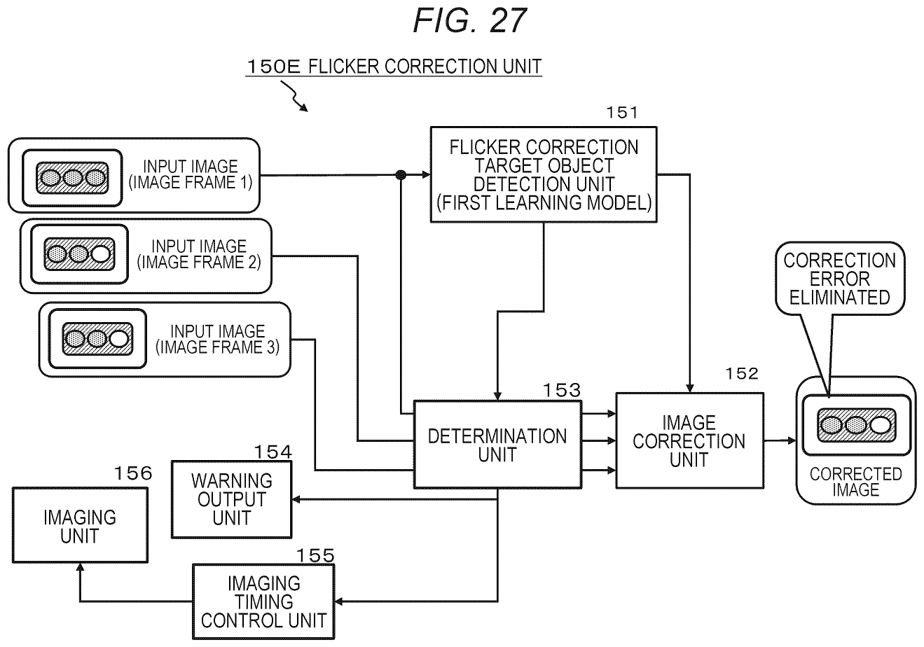

FIG. 27 is a diagram illustrating an example configuration of a flicker correction unit 150E having the respective components of the flicker correction unit 150C including the warning output unit 154 described with reference to FIG. 22 and the flicker correction unit 155D including the imaging timing control unit 155 described with reference to FIG. 25.

The flicker correction unit 150E having such a configuration is used in issuing a warning to the user or in performing automatic control on the image capturing timing, for example. Thus, flicker correction errors are eliminated.

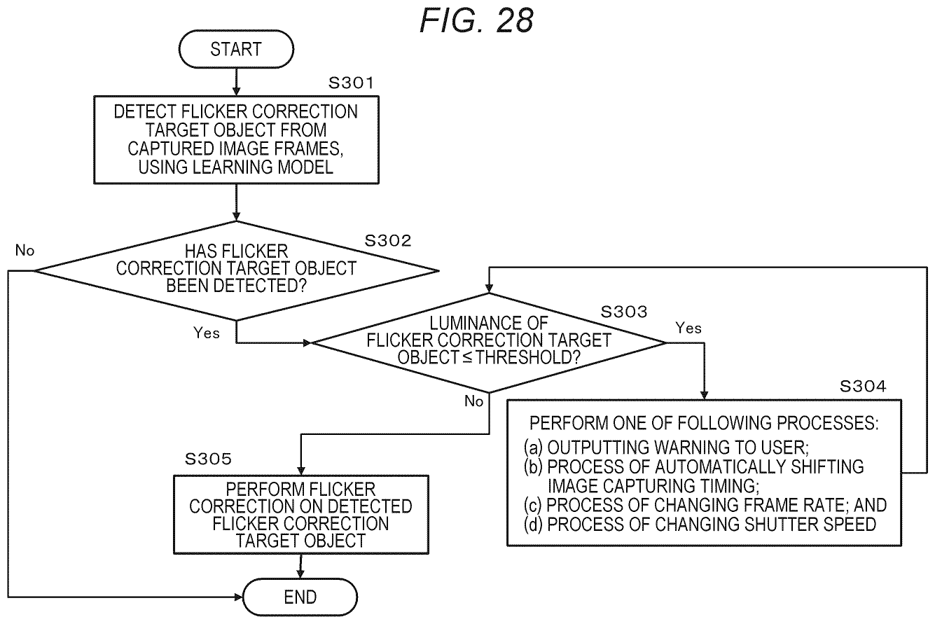

Referring next to a flow shown in FIG. 28, the sequence in a flicker correction process to be performed by the flicker correction unit according to the third embodiment is described.

In the description below, the processes in the respective steps in the flowchart shown in FIG. 28 are explained.

### (Step S301)

First, in step S301, the flicker correction unit detects flicker correction target objects from captured image frames, using a learning model.

This process is a process to be performed by the flicker correction target object detection unit (the first learning model) 151 of the flicker correction unit 150E illustrated in FIG. 27, for example.

The flicker correction target object detection unit (the first learning model) 151 analyzes whether or not there is a subject image that might cause a flicker from each of the image frames constituting a moving image captured by the camera, or whether or not there is a flicker correction target object.

### (Step S302)

Step S302 is a step of determining whether or not a flicker correction target object has been detected.

If a flicker correction target object has been detected, the process moves on to step S303.

If any flicker correction target object has not been detected, on the other hand, the process comes to an end.

Note that, in a case where there is a subsequent processing target image frame, the processes in step S301 and the subsequent steps are performed for the image frame.

### (Step S303)

Step S303 is carried out in a case where a flicker correction target object has been detected in step S302.

If a flicker correction target object has been detected in step S302, a check is made in step S303 to determine whether or not the luminance of the flicker correction target object detected in step S302 is equal to or lower than a prescribed threshold.

If it is determined that the luminance of the flicker correction target object is equal to or lower than the prescribed threshold, the process moves on to step S304.

If it is determined that the luminance of the flicker correction target object is neither equal to nor lower than the prescribed threshold, on the other hand, the process moves on to step S305.

This process is a process to be performed by the determination unit 153 of the flicker correction unit 150E illustrated in FIG. 27, for example.

### (Step S304)

The process in step S304 is performed in a case where it is determined in step S303 that the luminance of the flicker correction target object is equal to or lower than the prescribed threshold.

In this case, the flicker correction unit performs one of the following processes in step S304:
(a) outputting a warning to the user;
(b) a process of automatically shifting the image capturing timing;
(c) a process of changing the frame rate; and
(d) a process of changing the shutter speed.

“(a) Outputting a warning to the user” is a process described above with reference to FIGS. 22 to 24, and is a process in which the warning output unit 154 outputs a warning to the user so as to shift the image capturing timing.

“(b) A process of automatically shifting the image capturing timing” is a process described above with reference to FIGS. 25 to 26, and is a process in which the imaging timing control unit 155 automatically shifts and changes the image capturing timing.

“(c) A process of changing the frame rate” is a frame rate change process for setting the frame rate to 40 fps or 50 fps in a case where the current camera frame rate is 30 fps, for example. By performing this process, it becomes possible to capture an image that changes in luminance.

Further, “(d) a process of changing the shutter speed” is a process of changing the exposure time. For example, by setting the exposure time of one captured image frame to a long time, it becomes possible to capture an image in a high-luminance state.

Such a process may be performed.

When the process in step S304 is completed, the process returns to step S303.

In step S303, a check is made again to determine whether or not the luminance of the flicker correction target object detected in step S302 is equal to or lower than the prescribed threshold.

If it is determined that the luminance of the flicker correction target object is equal to or lower than the prescribed threshold, the process moves on to step S304.

If it is determined that the luminance of the flicker correction target object is neither equal to nor lower than the prescribed threshold, on the other hand, the process moves on to step S305, and a process such as outputting a warning is repeated.

If it is determined at last in step S303 that the luminance of the flicker correction target object is neither equal to nor lower than the prescribed threshold, the process moves on to step S305.

### (Step S305)

The flicker correction unit 150 performs a flicker correction process on the detected flicker correction target object in step S305.

This process is a process to be performed by the image correction unit 152 illustrated in FIG. 27.

The image correction unit 152 performs flicker correction on the flicker correction target objects detected by the flicker correction target object detection unit (the first learning model) 151.

The image correction unit 152 receives an input of a plurality of consecutively captured images, and uses the plurality of consecutively captured images, to perform a flicker correction process only on the image regions of the flicker correction target objects input from the flicker correction target object detection unit (the first learning model) 151, which is a process of eliminating flickers or an image correction process for reducing flickers.

As described above, the flicker correction process to be performed by the image correction unit 152 is one of the following processes, for example.

(Example 1 of a flicker correction process) A moving average is calculated among the latest several frames (three input image frames 1 to 3, for example) so that the luminance of the image regions of the flicker correction target objects becomes constant, and is set as the luminance of the image regions of the flicker correction target objects in each frame.

(Example 2 of a flicker correction process) A predetermined luminance (the maximum luminance, for example) among the latest several frames (three input image frames 1 to 3, for example) is selected so that the luminance of the image regions of the flicker correction target objects becomes constant, and is set as the luminance of the image regions of the flicker correction target objects in each frame.

(Example 3 of a flicker correction process) The image regions of the flicker correction target objects are replaced with images prepared in advance.

For example, one of these processes is performed, to execute image correction on the image regions of the flicker correction target objects detected from the captured image.

The corrected image generated through this process is an image in which flickers have been eliminated or reduced.

In the third embodiment, in a case where a flicker correction target object has a luminance equal to or lower than the threshold, and there is a possibility that a flicker correction error will occur, image capturing timing control or the like is performed, so that an image in which the flicker correction target object has a luminance equal to or higher than the threshold is obtained, and flicker correction is performed with the use of this image.

As such a process is performed, the occurrence of a flicker correction error can be prevented, and a correct flicker-corrected image can be generated.

Note that, in the third embodiment, the image region to be a flicker correction target is identified with a learning model. After that, the image correction unit 152 performs flicker correction only on the image region of the flicker correction target object, as in the first embodiment and the second embodiment.

As these processes are performed, there is no need to perform a flicker analysis on the entire captured images, and a flicker correction process can be performed only on the image regions of the flicker correction target objects. Thus, a high-speed and high-accuracy flicker correction process can be performed.

Note that the above third embodiment has been described as a configuration based on the first embodiment described above, but the configuration of the third embodiment can also be based on the second embodiment described above. That is, the determination unit 153, the warning output unit 154, and the imaging timing control unit 155 of the flicker correction unit 150E illustrated in FIG. 27 may be added to the configuration of the flicker correction unit 150B according to the second embodiment described above with reference to FIG. 11 and FIG. 17.

### 6. Example of the Hardware Configuration of an Image Processing Device

First, an image processing device according to the present disclosure may be formed with a smartphone having a camera function, a tablet terminal, a PC, or the like, for example.

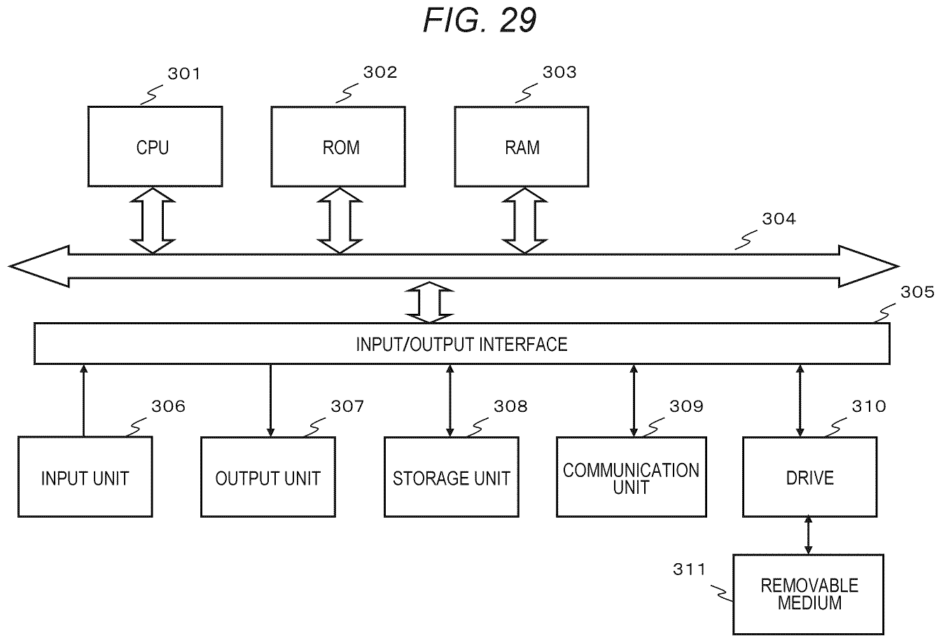

An example of the hardware configuration of a smartphone, a tablet terminal, or a PC as an example of an image processing device according to the present disclosure is now described with reference to FIG. 29. The hardware illustrated in FIG. 29 is a specific example of the hardware configuration of an image processing device according to the present disclosure.

A central processing unit (CPU) 301 functions as a control unit and a data processing unit that performs various kinds of processing in accordance with a program stored in a read only memory (ROM) 302 or a storage unit 308. For example, processing according to the sequences described in the above-described embodiments is performed. A random access memory (RAM) 303 stores programs to be executed by the CPU 301, data, and the like. The CPU 301, the ROM 302, and the RAM 303 are connected to one another by a bus 304.

The CPU 301 is connected to an input/output interface 305 via the bus 304, and an input unit 306 that includes a camera, various switches, a microphone, a sensor, and the like, and an output unit 307 that includes a display, a speaker, and the like are connected to the input/output interface 305.

The CPU 301 performs various processes in accordance with a command input from the input unit 306, and outputs a processing result to the output unit 307, for example.

The storage unit 308 connected to the input/output interface 305 includes a flash memory or the like, for example, and stores a program to be executed by the CPU 301 and various kinds of data. A communication unit 309 is formed with a proximity communication unit such as NFC, or a communication unit for Wi-Fi communication, Bluetooth (registered trademark) (BT) communication, and other data communication via a network such as the Internet or a local area network, and communicates with external devices.

A drive 310 connected to the input/output interface 305 drives a removable medium 311 such as a magnetic disk, an optical disk, a magneto-optical disk, or a semiconductor memory such as a memory card, and records or reads data.

### 7. Summary of Configurations According to the Present Disclosure

Embodiments of the present disclosure have been described in detail so far, with reference to specific examples. However, it is obvious that those skilled in the art can modify or substitute the embodiments without departing from the scope of the present disclosure. That is, the present invention has been disclosed in the form of examples, and should not be interpreted in a limited manner. To determine the gist of the present disclosure, the claims should be taken into consideration.

Note that the technology disclosed herein may have the following configurations.

(1) An image processing device including
a flicker correction unit that performs a flicker correction process, in which
the flicker correction unit includes:
a flicker correction target object detection unit that detects, from an image, a flicker correction target object that is a subject that is likely to cause a flicker; and
an image correction unit that performs a flicker correction process on an image region of the flicker correction target object detected by the flicker correction target object detection unit, and
the flicker correction target object detection unit performs a flicker correction target object detection process, using a learning model.

(2) The image processing device according to (1), in which
the learning model to be used by the flicker correction target object detection unit includes
a learning model generated by a learning process that uses a large number of images including the flicker correction target object, and a learning data set including identification data of the flicker correction target object included in each of the images.

(3) The image processing device according to (1) or (2), in which
the flicker correction target object detection unit
receives an input of one image frame forming a moving image, and detects the flicker correction target object from the input image frame, and
the image correction unit
receives an input of consecutive image frames including the image frame from which the flicker correction target object detection unit has detected the flicker correction target object, and performs a flicker correction process.

(4) The image processing device according to any one of (1) to (3), in which
the learning model to be used by the flicker correction target object detection unit includes
a learning model generated by a learning process that uses consecutive image frames of the moving image including the flicker correction target object, and a learning data set including identification data of the flicker correction target object included in each of the image frames.

(5) The image processing device according to (4), in which
the learning model to be used by the flicker correction target object detection unit includes
a learning model generated by a learning process that further uses frame rate information about a camera that has captured the moving image including the flicker correction target object.

(6) The image processing device according to (4) or (5), in which
the flicker correction target object detection unit
selectively uses a plurality of learning models in accordance with a frame rate of a camera that has captured the moving image.

(7) The image processing device according to any one of (4) to (6), in which
the flicker correction target object detection unit
receives an input of a plurality of consecutive image frames constituting the moving image, and detects the flicker correction target object from the input image frames, and
the image correction unit
receives an input of image frames including the consecutive image frames from which the flicker correction target object detection unit has detected the flicker correction target object, and performs a flicker correction process.

(8) The image processing device according to any one of (4) to (7), in which
the flicker correction target object detection unit
performs a process of receiving an input of a plurality of consecutive image frames constituting the moving image, distinguishing an object in a lighted state from an object in a blinking state, and detecting the object in the lighted state as the flicker correction target object.

(9) The image processing device according to any one of (4) to (8), in which
the flicker correction target object detection unit
performs a process of receiving an input of a plurality of consecutive image frames constituting the moving image and frame rate information about a camera that has captured the moving image, and selecting an object having a high flicker occurrence possibility as the flicker correction target object, in accordance with a frame rate of a camera that has captured the moving image.

(10) The image processing device according to any one of (1) to (9), in which
the image correction unit
performs a flicker correction process using only an image region of the flicker correction target object detected by the flicker correction target object detection unit, as a correction target region.

(11) The image processing device according to any one of (1) to (10), in which
the flicker correction target object detection unit
outputs coordinate information indicating an image region of the detected flicker correction target object to the image correction unit, and
the image correction unit
identifies the image region of the flicker correction target object on the basis of the coordinate information input from the flicker correction target object detection unit, and performs a flicker correction process in which only the image region of the flicker correction target object is set as a correction target region.

(12) The image processing device according to any one of (1) to (11), in which
the image correction unit performs an image correction process that is one of the following (a) to (c):
(a) an image correction process in which a moving average of luminance among the latest several frames is calculated so that the luminance of an image region of the flicker correction target object becomes constant, and the moving average is set as the luminance of the image region of the flicker correction target object in each image frame;
(b) an image correction process in which an image frame with a predetermined luminance among the latest several frames is selected so that the luminance of the image region of the flicker correction target object becomes constant, and the predetermined luminance is set as the luminance of the image region of the flicker correction target object in each image frame; and
(c) an image correction process in which the image region of the flicker correction target object is replaced with an image prepared in advance.

(13) The image processing device according to any one of (1) to (12), further including
a determination unit that receives an input of a plurality of consecutive image frames constituting a moving image, and determines whether or not a luminance level of the flicker correction target object included in the plurality of consecutive image frames is not higher than a prescribed threshold.

(14) The image processing device according to (13), further including:
a warning output unit that outputs a warning message to a display unit of a camera that is capturing a moving image, in which
the warning output unit
outputs the warning message for prompting a process of shifting an image capturing timing, on the basis of determination made by the determination unit that has determined that the luminance level of the flicker correction target object included in the plurality of consecutive image frames is not higher than the prescribed threshold.

(15) The image processing device according to (13) or (14), further including
an imaging timing control unit that causes a camera that is capturing a moving image to perform the process of shifting the image capturing timing, in which
the imaging timing control unit
causes the camera to perform the process of shifting the image capturing timing, on the basis of determination made by the determination unit that has determined that the luminance level of the flicker correction target object included in the plurality of consecutive image frames is not higher than the prescribed threshold.

(16) An image processing method implemented in an image processing device, in which
the image processing device includes a flicker correction unit that performs a flicker correction process,
the flicker correction unit performs
a flicker correction target object detection process to detect, from an image, a flicker correction target object that is a subject that is likely to cause a flicker, and
an image correction process to perform a flicker correction process on an image region of the flicker correction target object detected in the flicker correction target object detection process, and
a flicker correction target object detection process using a learning model is performed in the flicker correction target object detection process.

(17) A program for causing an image processing device to perform image processing, in which
the image processing device includes a flicker correction unit that performs a flicker correction process,
the program causes the flicker correction unit to perform
a flicker correction target object detection process to detect, from an image, a flicker correction target object that is a subject that is likely to cause a flicker, and
an image correction process to perform a flicker correction process on an image region of the flicker correction target object detected in the flicker correction target object detection process, and
a flicker correction target object detection process using a learning model is performed in the flicker correction target object detection process.

Furthermore, a series of processes described in the present specification can be performed by hardware, software, or a configuration obtained by combining hardware and software. In a case where processes are performed by software, a program in which the processing sequence is recorded can be installed into a memory in a computer incorporated in dedicated hardware and be executed, or the program can be installed into a general-purpose computer capable of executing various kinds of processing and be executed. For example, the program can be recorded beforehand in a recording medium. In addition to being installed into a computer from a recording medium, the program can be received via a network such as a local area network (LAN) or the Internet, and installed into a recording medium such as an internal hard disk or the like.

Note that the various processes described herein may be performed not only in chronological order in accordance with the description, but may also be performed in parallel or individually depending on the processing capability of the device that performs the processes or as necessary. Furthermore, a system in the present specification is a logical assembly of a plurality of devices, and is not limited to a system in which devices of the respective configurations are in the same housing.

### INDUSTRIAL APPLICABILITY

As described above, with a configuration according to an embodiment of the present disclosure, an image processing device that efficiently detects a flicker correction target object and performs a flicker correction process with high accuracy and at high speed is obtained.

Specifically, the image processing device includes a flicker correction unit that performs a flicker correction process, for example. The flicker correction unit includes: a flicker correction target object detection unit that detects, from an image, a flicker correction target object that is a subject that is likely to cause a flicker; and an image correction unit that performs a flicker correction process on the image region of the flicker correction target object detected by the flicker correction target object detection unit. The flicker correction target object detection unit performs a flicker correction target object detection process, using a learning model.

With this configuration, an image processing device that efficiently detects a flicker correction target object and performs a flicker correction process with high accuracy and at high speed is obtained.

### REFERENCE SIGNS LIST

10 Camera
21 Traffic light
22 Display
100 Image processing device (camera)
101 Imaging unit
102 Image processing unit
103 Image recording unit
104 Recording medium
105 Image reproduction unit
106 Display unit
120 Image processing device (external device)
121 Image input unit
122 Image processing unit
123 Image recording unit
124 Recording medium
125 Image reproduction unit
126 Display unit
150, 150B to E Flicker correction unit
151 Flicker correction target object detection unit (first learning model)
151B Flicker correction target object detection unit (second learning model)
152 Image correction unit
153 Determination unit
154 Warning output unit
155 Imaging timing control unit
156 Imaging unit
171 Learning process execution unit (first learning model generation unit)
172 Learning process execution unit (second learning model generation unit)
301 CPU
302 ROM
303 RAM
304 Bus
305 Input/output interface
306 Input unit
307 Output unit
308 Storage unit
309 Communication unit
310 Drive
311 Removable medium

1. An image processing device comprising
a flicker correction unit that performs a flicker correction process, wherein
the flicker correction unit includes:
a flicker correction target object detection unit that detects, from an image, a flicker correction target object that is a subject that is likely to cause a flicker; and
an image correction unit that performs a flicker correction process on an image region of the flicker correction target object detected by the flicker correction target object detection unit, and
the flicker correction target object detection unit performs a flicker correction target object detection process, using a learning model.

2. The image processing device according to claim 1, wherein
the learning model to be used by the flicker correction target object detection unit includes
a learning model generated by a learning process that uses a large number of images including the flicker correction target object, and a learning data set including identification data of the flicker correction target object included in each of the images.

3. The image processing device according to claim 1, wherein
the flicker correction target object detection unit
receives an input of one image frame forming a moving image, and detects the flicker correction target object from the input image frame, and
the image correction unit
receives an input of consecutive image frames including the image frame from which the flicker correction target object detection unit has detected the flicker correction target object, and performs a flicker correction process.

4. The image processing device according to claim 1, wherein
the learning model to be used by the flicker correction target object detection unit includes
a learning model generated by a learning process that uses consecutive image frames of the moving image including the flicker correction target object, and a learning data set including identification data of the flicker correction target object included in each of the image frames.

5. The image processing device according to claim 4, wherein
the learning model to be used by the flicker correction target object detection unit includes
a learning model generated by a learning process that further uses frame rate information about a camera that has captured the moving image including the flicker correction target object.

6. The image processing device according to claim 4, wherein
the flicker correction target object detection unit
selectively uses a plurality of learning models in accordance with a frame rate of a camera that has captured the moving image.

7. The image processing device according to claim 4, wherein
the flicker correction target object detection unit
receives an input of a plurality of consecutive image frames constituting the moving image, and detects the flicker correction target object from the input image frames, and
the image correction unit
receives an input of image frames including the consecutive image frames from which the flicker correction target object detection unit has detected the flicker correction target object, and performs a flicker correction process.

8. The image processing device according to claim 4, wherein
the flicker correction target object detection unit
performs a process of receiving an input of a plurality of consecutive image frames constituting the moving image, distinguishing an object in a lighted state from an object in a blinking state, and detecting the object in the lighted state as the flicker correction target object.

9. The image processing device according to claim 4, wherein
the flicker correction target object detection unit
performs a process of receiving an input of a plurality of consecutive image frames constituting the moving image and frame rate information about a camera that has captured the moving image, and selecting an object having a high flicker occurrence possibility as the flicker correction target object, in accordance with a frame rate of a camera that has captured the moving image.

10. The image processing device according to claim 1, wherein
the image correction unit
performs a flicker correction process using only an image region of the flicker correction target object detected by the flicker correction target object detection unit, as a correction target region.

11. The image processing device according to claim 1, wherein
the flicker correction target object detection unit
outputs coordinate information indicating an image region of the detected flicker correction target object to the image correction unit, and
the image correction unit identifies the image region of the flicker correction target object on a basis of the coordinate information input from the flicker correction target object detection unit, and performs a flicker correction process in which only the image region of the flicker correction target object is set as a correction target region.

12. The image processing device according to claim 1, wherein
the image correction unit performs an image correction process that is one of the following (a) to (c):
(a) an image correction process in which a moving average of luminance among latest several frames is calculated so that the luminance of an image region of the flicker correction target object becomes constant, and the moving average is set as the luminance of the image region of the flicker correction target object in each image frame;
(b) an image correction process in which an image frame with a predetermined luminance among the latest several frames is selected so that the luminance of the image region of the flicker correction target object becomes constant, and the predetermined luminance is set as the luminance of the image region of the flicker correction target object in each image frame; and
(c) an image correction process in which the image region of the flicker correction target object is replaced with an image prepared in advance.

13. The image processing device according to claim 1, further comprising
a determination unit that receives an input of a plurality of consecutive image frames constituting a moving image, and determines whether or not a luminance level of the flicker correction target object included in the plurality of consecutive image frames is not higher than a prescribed threshold.

14. The image processing device according to claim 13, further comprising:
a warning output unit that outputs a warning message to a display unit of a camera that is capturing a moving image, wherein
the warning output unit
outputs the warning message for prompting a process of shifting an image capturing timing, on a basis of determination made by the determination unit that has determined that the luminance level of the flicker correction target object included in the plurality of consecutive image frames is not higher than the prescribed threshold.

15. The image processing device according to claim 13, further comprising
an imaging timing control unit that causes a camera that is capturing a moving image to perform the process of shifting the image capturing timing, wherein
the imaging timing control unit
causes the camera to perform the process of shifting the image capturing timing, on a basis of determination made by the determination unit that has determined that the luminance level of the flicker correction target object included in the plurality of consecutive image frames is not higher than the prescribed threshold.

16. An image processing method implemented in an image processing device, wherein
the image processing device includes a flicker correction unit that performs a flicker correction process,
the flicker correction unit performs
a flicker correction target object detection process to detect, from an image, a flicker correction target object that is a subject that is likely to cause a flicker, and
an image correction process to perform a flicker correction process on an image region of the flicker correction target object detected in the flicker correction target object detection process, and
a flicker correction target object detection process using a learning model is performed in the flicker correction target object detection process.

17. A program for causing an image processing device to perform image processing, wherein
the image processing device includes a flicker correction unit that performs a flicker correction process,
the program causes the flicker correction unit to perform
a flicker correction target object detection process to detect, from an image, a flicker correction target object that is a subject that is likely to cause a flicker, and
an image correction process to perform a flicker correction process on an image region of the flicker correction target object detected in the flicker correction target object detection process, and
a flicker correction target object detection process using a learning model is performed in the flicker correction target object detection process.
